(19) United States
(12) Patent Application Publication
(10) Pub. No.: US 2015/0169570 A1
(43) Pub. Date: Jun. 18, 2015

(54) METHOD AND DEVICE FOR MANAGING DATA

(71) Applicant: SAMSUNG ELECTRONICS CO., LTD., Suwon-si (KR)

(72) Inventors: Hyo-taek SHIM, Seongnam-si (KR); Bok-deuk Jeong, Yongin-si (KR)

(73) Assignee: Samsung Electronics Co., Ltd.

(21) Appl. No.: 14/574,960

(22) Filed: Dec. 18, 2014

(30) Foreign Application Priority Data
Dec. 18, 2013 (KR) 10-2013-0158607

(51) Int. Cl. G06F 17/30

(52) U.S. Cl. CPC G06F 17/3033

(57) ABSTRACT

A method of managing data includes controlling to form packed bucket data by packing user data and a pointing map indicating a storage location of the user data; controlling to extract a specific key value that is to be browsed by a user from the packed bucket data; and exchanging the specific key value through a smart interface.

### CROSS-REFERENCE TO RELATED APPLICATIONS

This application claims the priority benefit of Korean Patent Application No. 10-2013-0158607, filed on Dec. 18, 2013, in the Korean Intellectual Property Office, the disclosure of which is incorporated herein in its entirety by reference.

### BACKGROUND

1. Field

Example embodiments of the following disclosure relate to a method and device for managing data, and more particularly, to a method and device for efficiently controlling data according to a characteristic of a storage device.

2. Description of the Related Art

Since the use of client devices has recently increased, data that is to be managed by a computer, a server, etc. has also dramatically increased. Thus, many data management methods have been developed for a host terminal, such as a computer, to efficiently manage data.

In particular, since the amount of data processed by a server increases due to the development in wireless communication technology, the host terminal needs more storage space for processing and storing many pieces of data. Various storage devices are used in host terminals to increase the efficiency of a data storage space.

However, storage devices use different methods of managing, such as storing, deleting, and reading, and thus, a new method of managing the data is necessary for promptly storing and browsing the data and increasing data storage efficiency.

### SUMMARY

Example embodiments of the present disclosure include a method of managing data, and more particularly, a method and device for efficiently controlling the data.

Additional aspects will be set forth in part in the description which follows and, in part, will be apparent from the description, or may be learned by practice of the presented embodiments.

According to one or more embodiments, a method of managing data includes controlling to form packed bucket data by packing user data and a pointing map indicating a storage location of the user data; controlling to extract a specific key value that is to be browsed by a user from the packed bucket data; and exchanging the specific key value through a smart interface.

The pointing map may include information indicating the storage location of the user data based on a key value corresponding to the user data and hash index information generated by using a hash function.

The pointing map may further comprise a valid display field indicating information regarding whether an entry of the pointing map is empty, and a tag field to store a portion of the key value corresponding to the user data.

Further, the tag field of the pointing map may be compared with the specific key value before the stored user data is read.

The controlling to form the packed bucket data may include: generating an offset filter including tag information identifying the user data of the packed bucket data based on a key value corresponding to the user data and hash index information generated by using a hash function.

The controlling to extract of the specific key value may include: comparing the tag information of the offset filter and the specific key value that is to be browsed; and comparing the key value corresponding to the user data of the packed bucket data and the specific key value that is to be browsed based on a comparison result.

Further, the extracting may include determining whether user data that is to be browsed is stored in a first region of a storage device, and simultaneously determining whether the user data that is to be browsed is stored in a second region of the storage device.

Moreover, the extracting may include determining whether user data that is to be browsed is stored in a first region of a storage device, and sequentially determining whether the user data that is to be browsed is stored in a second region of the storage device.

The exchanging may include: exchanging the specific key value based on parallel unit information regarding a size of data acquired through the smart interface that may be parallel-processed in a storage device.

The controlling to form the packed bucket data may include: allocating a second region including one or more buckets rearranging user data stored in a first region based on a key value corresponding to the user data; determining a bucket of the second region; and storing packed bucket data including the user data in the determined the bucket.

The controlling to form the packed bucket data may include: generating information regarding a size of the user data included in the bucket and information regarding an address of the user data included in the bucket; and storing the information regarding the size of the user data and the information regarding the address of the user data in the bucket.

The controlling to form the packed bucket data may include: allocating a third region rearranging user data included in the second region; and rearranging the user data included in the second region in the third region based on a key value corresponding to the user data included in the second region.

A size of the third region may be a predetermined multiplication of sizes of the second region.

The controlling to form the packed bucket data may include: erasing the user data stored in the second region that is the same as the user data stored in the third region.

The allocating may include: allocating at least one of the first region, the second region, and the third region based on erase unit information regarding a size used to erase data of a storage device.

The storing may include: storing the packed bucket data based on parallel unit information regarding a size of data that may be parallel-processed in the storage device

The allocating may include: allocating the second region based on region information determined based on a property of the user data.

The method may further include: acquiring at least one of information regarding a storage device including erase unit information of a size used to erase data of the storage device, parallel unit information regarding a size of data that may be parallel-processed in the storage device, information regarding an address of a region in which a current data write operation is performed and an address of a region in which a data write operation is to be performed after the current data write operation, storage unit information regarding a minimum unit storing the data in the storage device, and region identification information regarding the number identifying regions that store the data in the storage device.

The method may further include: transmitting control information controlling to store and read data of the storage device based on the acquired at least one of the information regarding the storage device.

According to one or more embodiments, an apparatus for managing data includes: a host terminal including a packed bucket data forming unit for controlling to form packed bucket data by packing user data and a pointing map indicating a storage location of the user data, and an extraction unit for controlling to extract a specific key value that is to be browsed by a user from the packed bucket data; and a storage device for storing the user data and the packed bucket data and receiving the specific key value from the host terminal.

When the pointing map exceeds a predetermined percentage of a total capacity of memory, the host terminal may perform the packing of the user data and the pointing map into the packed bucket data, and may erase the storage location of the user data from the pointing map, thereby reducing an amount of data stored in the memory.

The pointing map may include information indicating the storage location of the user data based on a key value corresponding to the user data and hash index information generated by using a hash function.

The packed bucket data forming unit may include an offset filter generation unit for generating an offset filter including tag information identifying the user data of the packed bucket data based on a key value corresponding to the user data and hash index information generated by using a hash function.

The extraction unit may compare the tag information of the offset filter and the specific key value that is to be browsed, and compares the key value corresponding to the user data of the packed bucket data and the specific key value that is to be browsed based on a comparison result.

The host terminal further may include: a communication unit for exchanging the specific key value through a smart interface, wherein the communication unit exchanges the key value based on parallel unit information regarding a size of data acquired through the smart interface that may be parallel-processed in a storage device.

The packed bucket data forming unit may include: a region allocation unit for allocating a second region including one or more buckets rearranging user data stored in a first region based on the key value corresponding to the user data; a bucket determination unit for determining a bucket in the second region; and a storage control unit for storing packed bucket data including the user data in the determined the bucket.

The packed bucket data forming unit may include: a bucket information generation unit for generating information regarding a size of the user data included in the bucket and information regarding an address of the user data included in the bucket, wherein the storage control unit stores the information regarding the size of the user data and the information regarding the address of the user data in the bucket.

The region allocation unit may allocate a third region rearranging user data included in the second region, wherein the storage control unit rearranges the user data included in the plurality of second regions in the third region based on a key value corresponding to the user data included in the plurality of second regions.

A size of the third region is a predetermined multiplication of sizes of the plurality of second regions.

The storage control unit may erase the user data stored in the second region that is the same as the user data stored in the third region.

The region allocation unit may allocate at least one of the first region, the second region, and the third region based on erase unit information regarding a size used to erase data of the storage device.

The storage control unit may store the packed bucket data based on parallel unit information regarding a size of data that may be parallel-processed in the storage device.

The storage control unit may allocate the second region based on region information determined based on a property of the user data.

The host terminal may acquire at least one of information regarding the storage device including erase unit information of a size used to erase data of the storage device, parallel unit information regarding a size of data that may be parallel-processed in the storage device, information regarding an address of a region in which a current data write operation is performed and an address of a region in which a data write operation is to be performed after the current data write operation, storage unit information regarding a minimum unit storing data in the storage device, and region identification information regarding the number of identifying regions that store data in the storage device.

The storage control unit may transmit control information controlling to store and read data of the storage device based on the acquired at least one of the information regarding the storage device.

According to one or more embodiments, a host terminal controls to form packed bucket data by packing user data and a pointing map indicating a storage location of the user data, and to extract a specific key value that is to be browsed by a user from the packed bucket data.

According to one or more embodiments, a storage device stores packed bucket data by packing user data and a pointing map indicating a storage location of the user data, and exchanges a specific key value that is to be browsed by a user from the packed bucket data.

According to one or more embodiments, a method of managing data that is performed by a host terminal includes: controlling to form packed bucket data by packing user data and a pointing map indicating a storage location of the user data, and controlling to extract a specific key value that is to be browsed by a user from the packed bucket data.

According to one or more embodiments, a method of managing data that is performed by a storage device includes: storing packed bucket data by packing user data and a pointing map indicating a storage location of the user data, and exchanging a specific key value that is to be browsed by a user from the packed bucket data.

According to one or more embodiments, a data management apparatus may include: a host terminal including a first application and a second application, the first application generating first data and the second application generating second data; a storage device to allocate a plurality of regions to store the first data and the second data, based on a characteristic of the storage device.

Further, the data management apparatus may allocate the plurality of regions, such that a size of the regions to store the first data and the second data are determined based on erase unit information of the storage device.

The data management apparatus may also store the first data in a first region and the second data in a second region, so that a size of the first and second regions is determined based on erase unit information of the storage device.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a block diagram of a system according to an example embodiment;

FIG. 2 illustrates a diagram for explaining a method of storing user data according to an example embodiment;

FIG. 3 is a flowchart showing a method of managing data according to an example embodiment;

FIG. 4 illustrates a block diagram for explaining a controller of a host terminal according to an example embodiment;

FIG. 5 is a detailed flowchart showing a method of managing data according to an example embodiment;

FIG. 6 is a flowchart showing a method of managing data according to another example embodiment;

FIG. 7 illustrates a block diagram for explaining a host terminal according to an example embodiment;

FIG. 8 is a flowchart showing a method of managing data according to another example embodiment;

FIG. 9 is a flowchart showing a method of managing data according to another example embodiment;

FIG. 10 illustrates a block diagram for explaining a controller of a host terminal according to another example embodiment;

FIG. 11 is a flowchart showing a method of managing data according to another example embodiment;

FIG. 12 is a flowchart showing a method of managing data according to another example embodiment;

FIG. 13 illustrates a block diagram of a storage device according to an example embodiment;

FIG. 14 illustrates a diagram for explaining a method of rearranging data according to an example embodiment;

FIG. 15 illustrates a diagram for explaining structures of a bucket and an offset filter according to an example embodiment;

FIG. 16 illustrates a diagram for explaining a method of rearranging data according to another example embodiment;

FIG. 17 illustrates a diagram for explaining a method of rearranging data according to another example embodiment;

FIG. 18 illustrates a diagram for explaining a method of allocating data storage regions according to an example embodiment;

FIG. 19 is a flowchart showing a data management method performed by a host terminal according to an example embodiment; and

FIG. 20 is a flowchart showing a data management method performed by a storage device according to an example embodiment.

### DETAILED DESCRIPTION

Most of the terms used herein are general terms that have been widely used in the technical art to which the present invention pertains. However, some of the terms used herein may be created reflecting intentions of technicians in this art, precedents, or new technologies. Also, some of the terms used herein may be arbitrarily chosen by the present applicant. In this case, these terms are defined in detail below. Accordingly, the specific terms used herein should be understood based on the unique meanings thereof and the whole context of the present disclosure.

In the present disclosure, it should be understood that the terms, such as ‘including’ or ‘having’, are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. Also, the terms, such as ‘unit’ or ‘module’, should be understood as a unit that processes at least one function or operation and that may be embodied in a hardware manner, a software manner, or a combination of the hardware manner and the software manner. As used herein, the term “and/or” includes any and all combinations of one or more of the associated listed items. Expressions such as “at least one of”, when preceding a list of elements, modify the entire list of elements and do not modify the individual elements of the list.

User data throughout the disclosure may mean data configured in various forms. In particular, the user data may correspond to and include a key value, and may mean data configured as a set of the key value and data. The key value, which is reference data when storing and browsing data, may be set as arbitrary information based on a user input in a data management device.

That is, although the present disclosure describes the user data for convenience of description, the user data does not mean data in a specific form. The user data may mean not only one user datum, such as a user data set, but also a plurality of user data sets, such as first user data and second user data, in the present specification. According to an embodiment, the user data set may mean a set of user data and a key of the user data.

In addition, a bucket throughout the present disclosure may mean a region that stores the user data based on index information generated according to the key value. That is, the bucket may mean a region of memory or of a storage device allocated to store the user data in a storage device.

Further, the index information, which is information generated based on the key value corresponding to the user data, may mean information relating to a location and an order the user data is stored. The index information according to an embodiment may include hash index information based on the key value and a hash function.

The meaning that the data management device performs a specific operation throughout the present disclosure may include the meaning that the data management device controls a host terminal and the storage device that are included therein such that the host terminal and the storage device may perform the specific operation. The meaning may also include the meaning that the host terminal included in the data management device controls the storage device.

In addition, the storage device throughout the present disclosure may include a solid state drive (SSD). However, the present disclosure is not limited to the use of an SSD as the storage device. For example, the storage device may include any and all devices that store data.

The meaning that an element and an element unit processes and performs a specific operation may include the meaning that a server device controls the element and the element unit to process and perform the specific operation.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

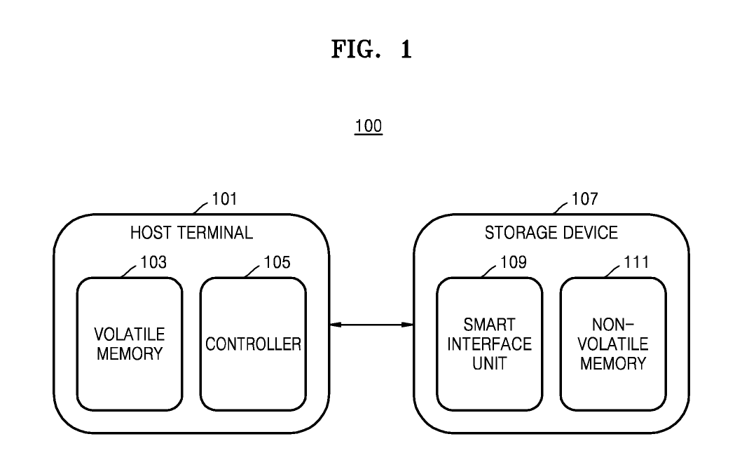

FIG. 1 illustrates a block diagram of a system according to an example embodiment.

Referring to FIG. 1, a data management device 100 according to the present embodiment may include at least a host terminal 101 and a storage device 107.

Depending on embodiments, the host terminal 101 may include a volatile memory 103 and a controller 105.

For example, the host terminal 101 of the present embodiment may include any of a desktop computer, a cellular phone, a smart phone, a laptop computer, a tablet PC, an e-book reader, a digital broadcasting terminal, a personal digital assistant (PDA), a portable multimedia player (PMP), a navigation system, an MP3 player, a digital camera, an Internet protocol television (IPTV), a digital television (DTV), a consumer electronics (CE) device (for example, a refrigerator with a display device, an air conditioner, etc.) but is not limited thereto. The host terminal 101 may include any and/or all devices that manage data.

The host terminal 101 may store data in the storage device 107 or read the data from the storage device 107. That is, the host terminal 101 may control the storage device 107 to store and read the data.

Further, the volatile memory 103 of the host terminal 101 may include a random access memory (RAM). The RAM may include a DRAM, an SRAM, etc. and for the sake of brevity, its detailed description is omitted.

The volatile memory 103 may store information regarding a map and a filter used to browse data, such as user data.

The controller 105 of the host terminal 101 may determine a region in which the data is to be stored and may provide information regarding the region that stores the determined data to the storage device 107. The controller 105 of the host terminal 101 may obtain at least one of erase unit information of an erase size unit of the data, address information of the region that stores the data, parallel unit information of a data size used to parallel-process the data, storage unit information of a minimum unit for storing the data, and region identification information that is information regarding the number identifying regions that store the data, from the storage device 107.

The controller 105 of the host terminal 101 may include a computation processing device, such as a central control device. Further, the host terminal 105 may include a control unit other than the controller 105.

The storage device 107 may include a smart interface unit 109 and a non-volatile memory 111. According to an embodiment, the storage device 107 may include the SSD. However, the storage device 107 is not limited to this example and may include various storage devices, such as a hard disk.

The smart interface unit 109 of the storage device 107 may control the non-volatile memory 111 of the storage device 107. The smart interface unit 109 may process the data transmitted from the host terminal 101.

In particular, the smart interface unit 109 may receive various control signals from the controller 105 of the host terminal 101 and then store the data in the non-volatile memory 111 of the storage device 107 based on the received control signals. The smart interface unit 109 may read the stored data from the non-volatile memory 111 according to a request of the host terminal 101 and transmit the data to the host terminal 101.

For example, the smart interface unit 109 may provide the erase unit information indicating the erase size unit of the data, the address information of the region that stores the data, the parallel unit information of the data size used to parallel-process the data, the storage unit information of the minimum unit for storing the data, and the region identification information of the number identifying the regions that store the data, to the host terminal 101.

As another example, the controller 105 of the host terminal 101 may obtain the parallel unit information, that is, information regarding a unit used to parallel-read (a read operation) and store (a write operation) the data in the storage device 107 through an application programming interface (API) such as GetParallelReadsize( ) and GetParallelWriteSize( ). The controller 105 of the host terminal 101 may obtain the erase unit information indicating a unit used to erase the data in the storage device 107 through an API, such as GetEraseUnitSize( ).

The controller 105 of the host terminal 101 may obtain the information regarding the number used to classify the region that stores the data in the storage device 107 from the storage device 107 through an API, such as GetMaxRegionNum( ). The controller 105 of the host terminal 101 may control the storage device 107 to designate or cancel the region that stores the data through an API, such as AllocRegion( )/DealloccRegin( ). An API function, such as AllocRegion( )/DealloccRegin( ), may be used along with a variable relating to the region.

The controller 105 of the host terminal 101 may obtain an address of a region or a block that is currently stored in the storage device 107 and an address of a block of a subsequent region that is to store the data from the storage device 107 through an API, such as GetregionOffset( ). In particular, GetregionOffset( ) may be used along with the variable relating to the region.

The controller 105 of the host terminal 101 may control the storage device 107 to change a region or a block that stores current data in the storage device to another region or another block through an API, such as ResetRegionOffset( ).

The controller 105 of the host terminal 101 may obtain the storage unit information of the minimum unit for storing the data in the storage device 107 from the storage device 107 through an API, such as GetRegionUnitSize( ).

The controller 105 of the host terminal 101 may control the storage device 107 to classify regions according to types of data received by the storage device 107 and store the data through an API, such as WriteToRegion( ) Further, the controller 105 may control the storage device 107 to classify regions and copy the data in the storage device 107 through an API, such as CopytoRegion( ). The APIs, such as WriteToRegion( ) and CopytoRegion( ) may be used along with variables, such as the region, the region size, the address information, and the like.

That is, the controller 105 of the host terminal 101 may control the smart interface unit 109 of the storage device 107 through the smart interfaces such as the above APIs to obtain information regarding the storage device 107, such as the parallel unit information, the erase unit information, the storage unit information of the minimum unit for storing the data, the region identification information of the number identifying the regions that store the data, and address information of the region that stores the data from the storage device 107.

Depending on embodiments, the data may include user data, and the storage device 107 may include the SSD.

Moreover, as an example, the non-volatile memory 111 may include a flash memory, a phase change RAM (PRAM), a ferroelectric RAM (FRAM), a magnetic RAM (MRAM), etc. and may also include a memory in a combination of two or more memories. According to an embodiment, the storage device 107 may include the RAM.

According to an embodiment, the storage device 107 may include a first memory unit that is the non-volatile memory 111 and a second memory unit that is the RAM, however, the present disclosure is not limited thereto.

Depending on embodiments, the host terminal 101 and the storage device 107 may further include additional elements.

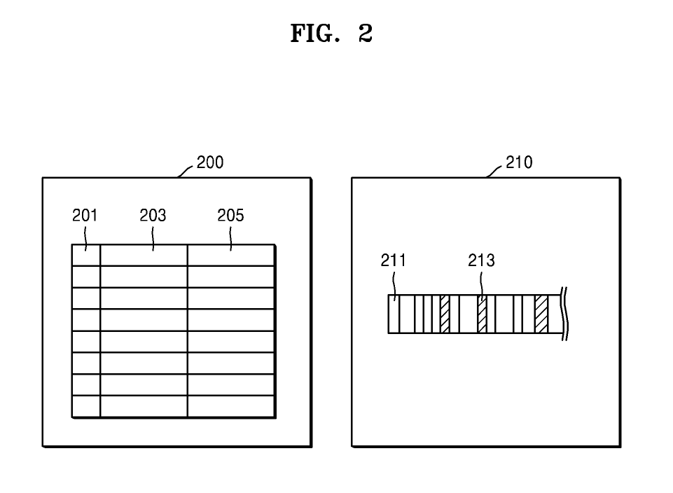

FIG. 2 illustrates a diagram for explaining a method of storing user data according to an example embodiment.

For example, a data management device may be a server that manages, such as stores, erases, reads, etc., data between a host terminal and a storage device. Depending on embodiments, the data management device may be a device included in the host terminal or the storage device. Further, according to example embodiments, the data management device may be a controller of the host terminal or the server itself.

The data management device may store user data in the storage device. The user data may have a variable size.

The data management device may obtain index information based on a value of a key corresponding to the user data. The index information may include bucket number information or digest information. That is, the index information may be information indicating a bucket in which the user data is stored.

Moreover, the data management device may store the user data in the storage device. The storage device of the present embodiment may include an SSD. In addition, according to an embodiment, the storage device of FIG. 2 may correspond to the storage device 107 of FIG. 1.

Referring to FIG. 2, the storage device may store the user data received from the host terminal in a first region 210 thereof according to the control of the data management device. In this regard, the first region 210 of the storage device may be configured as a flash memory, may not be overwritten, and may store the user data in an empty region 211, for example. That is, the storage device may store the user data in the empty region 211 in which no data is stored, and may not store data in a region 213, which is a shaded area of FIG. 2, in which data is already and previously stored.

The data management device may store address information of the first region 210 of the storage device in which the user data is stored in a pointing map 200. That is, the pointing map 200 may refer to information indicating a location of the stored user data and a space in which the information indicating the location of the stored user data is stored.

For example, the pointing map 200 may be stored in a volatile memory of the host terminal and in the first region of the storage device. However, the pointing map 200 may also be stored elsewhere, depending on embodiments.

Referring to FIG. 2, the pointing map 200 may include a valid display field 201, a tag field 203 indicating identification information, and an address information field 205.

The valid display field 201 may indicate information displaying whether an entry of the pointing map 200, that is, a space in which address information is stored, is empty according to the index information. The entry, which includes the valid display field 201, the tag field 203, and the address information field 205, may mean a space in which information regarding one piece of user data is stored.

The tag field 203 may store a part of the value of the key corresponding to the user data so that the data management device may provide information determining whether user data that is to be read corresponds to user data that is to be browsed before reading the entire user data from the storage device. For example, information included in the tag field 203 may be a last 3-digit bit of a bit string of the key value.

Further, the address information field 205 may include the information indicating the location of the stored user data.

The pointing map 200 may store information regarding a plurality of user data sets. For example, the data management device may sequentially store address information of user data having index information as 0 in the pointing map 200. The pointing map 200 may store information regarding a plurality of user data sets having the same index information.

Since the plurality of user data sets has the same index information, the data management device may compare a value stored in the tag field 203 of the pointing map 200 with a key value that is to be browsed before reading the user data from the storage device.

For example, if user data including information regarding a name and a school of each user is present, and a key value corresponding to the user data is a phone number, the data management device may acquire index information of the user data based on the phone number, that is, the key value. The data management device may store the user data in the first region 210 of the storage device, and may store an address in which the user data is stored in the pointing map 200 based on the index information. That is, the data management device may sequentially address information of the user data having the same index information in the pointing map 200 based on the index information.

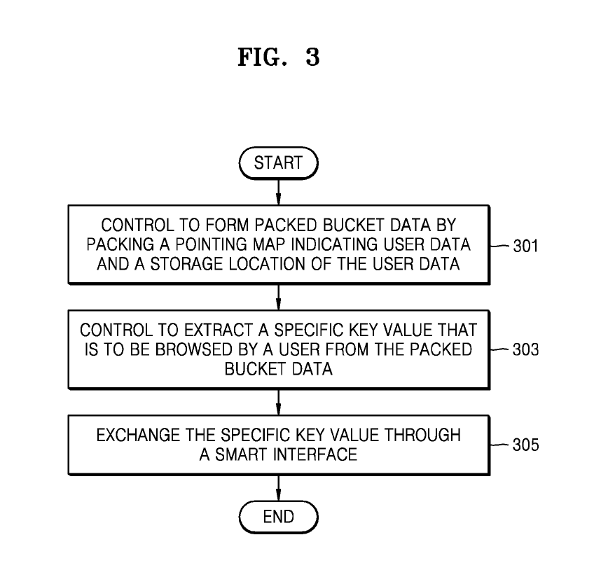

However, when a data size of each of the user data sets included in the user data is small but the number of the user data sets is many, if the storage method of FIG. 2 is used, capacity of the pointing map 200 may be gradually increased. That is, since the pointing map 200 includes the address information of each of the user data sets, the more the number of the user data sets, the greater the size of the pointing map 200. Thus, the data management device may efficiently manage the data by additionally using a method of FIG. 3.

FIG. 3 is a flowchart showing a method of managing data according to an example embodiment.

In operation 301, a data management device may control to pack user data into at least one bucket and a pointing map indicating a storage location of the user data to form packed bucket data.

The data management device may store first user data in a bucket of a region of a storage device allocated by the data management device based on information corresponding to a key value of the first user data, such as a pointing map.

For example, the user data includes a user data set, such as the first user data and second user data. The pointing map includes index information of the user data and information indicating a location of the user data so that the data management device packs the first user data and the second user data stored in the storage device based on the information included in the pointing map to form the packed bucket data.

The data management device may store the information stored in the pointing map, together with the user data, in the bucket.

That is, the host terminal included in the data management device may control the storage device to form the packed bucket data. The storage device included in the data management device may store the packed bucket data formed by packing the pointing map indicating the user data and the storage location of the user data.

The packed bucket data may mean data included in the same bucket. That is, the packed bucket data may mean user data stored in the same bucket based on the index information and may store one or more user data sets, such as the first user data and the second user data, in the same bucket.

The data management device may store the user data in a first region of the storage device. That is, the data management device may control the storage device to store the user data in the first region. The first region may mean an arbitrary region in a non-volatile memory of the storage device.

The data management device may acquire hash index information by using a key value corresponding to the user data and a hash function. The data management device may store address information storing the user data in the pointing map based on the acquired hash index information. That is, the pointing map may store information indicating the storage location of the user data based on the hash index information generated by using the key value corresponding to the user data and the hash function. This corresponds to the description with respect to FIG. 2 above.

The data management device may allocate a second region including one or more buckets that rearrange the user data stored in the first region. The second region may be a continuous space including one or more buckets. The bucket may mean a region storing the user data including the same index information and may store the one or more user data sets such as the first user data and the second user data as described above. For example, the data management device may rearrange the user data stored in the first region and store the rearranged user data of the first region in the second region.

The user data stored in the bucket may have a variable size. The number of user data sets that may be stored in each bucket of the same region may be the same or different.

The second region may mean a region allocated to rearrange and store the user data stored in the first region. That is, the second region may include an arbitrary region in the non-volatile memory included in the storage device and may be a different region from the first region.

The data management device may allocate the second region based on erasure unit information that is information regarding a data erasure size of the storage device.

The storage device may be an SSD that may include a flash memory. The flash memory may include a plurality of blocks that are configured as a plurality of pages. The flash memory erases data in a block unit, and thus the data management device may allocate the second region according to a multiple of a block unit size. For example, when one block has 129 MB, the data management device may allocate the second region as a size of 128 MB or 256 MB.

The data management device may allocate the second region according to a property of the user data. That is, the data management device may allocate a plurality of second regions according to a property of data, and thus the user data may be rearranged in each of the second regions according to the property.

The property of the user data may include a size of the user data, a type of an application that generates the user data, etc., and the like.

The data management device may determine buckets of the second region based on the index information. The data management device may rearrange and store the user data stored in the first region in the buckets of the second region based on the index information.

That is, the data management device may read at least one piece of user data stored in the first region based on the address information stored in the pointing map, and may store the read user data in each of the buckets of the second region based on the index information.

The second region may be identified by the buckets each storing the user data having the same index information. The buckets are sequentially arranged according to the index information so that the data management device may read user data that is to be browsed without the address information of each piece of the user data. For example, user data stored in a singular bucket may correspond to the same index information, and user data stored in another singular bucket may correspond to other different index information.

In addition, the data management device may generate an offset filter including tag information identifying the user data stored in the buckets of the second region. The data management device may store the offset filter in the host terminal or in the memory of the storage device.

The data management device may generate the offset filter identifying the user data in the packed bucket data based on the hash index information generated by using the key value corresponding to the user data included in the packed bucket data and the hash function.

The data management device may erase the user data rearranged in the second region from the first region. The data management device may delete the address information of the user data rearranged in the second region from the pointing map.

The user data stored in the first region may not be continuously stored. The storage device sequentially stores the user data in an empty region excluding a region in which data is already stored, and thus, when the data management device browses the user data, the address information of the user data may be necessary. However, according to an embodiment, since the user data arbitrarily stored in the first region is stored in each of the buckets of the second region determined based on the index information, the address information of the user data may not be necessarily stored in the pointing map, and thus a size of the pointing map may not exceed a predetermined size.

The data management device may generate information regarding the number of the user data including the buckets and the address information of the buckets of the user data stored in the buckets and may store the information in the buckets.

The data management device may store the user data based on parallel unit information that is information regarding a size of data parallel-processed by the storage device when rearranging the user data stored in the first region. For example, when the flash memory may store data having a size of 8 KB at a time through each of 8 channels, the data management device may control the used data to be stored in the second region in a size unit of 64 KB when storing the user data from the first region to the second region.

When a memory including a volatile memory of the host terminal that stores the pointing map uses more than a predetermined percent of a total capacity of the memory, the data management device performs operation 301 and erases the address information of the rearranged user data from the pointing map, thereby reducing an amount of data stored in the memory.

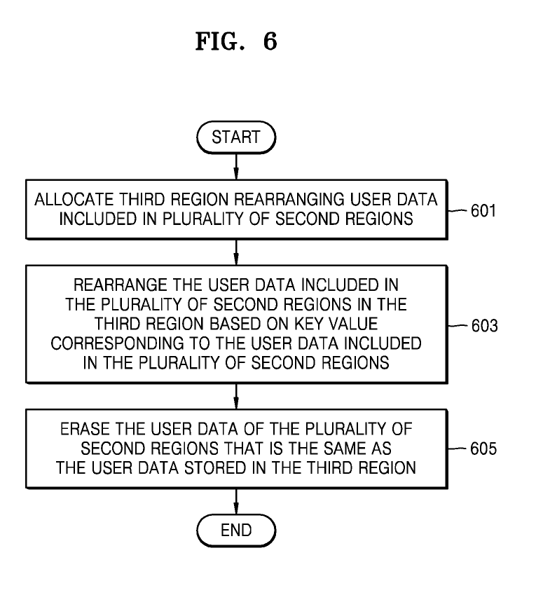

In addition, according to an embodiment, the data management device may allocate a third region to rearrange the user data stored in a plurality of second regions, and may store at least one piece of user data stored in the second regions in one or more buckets included in the allocated third region. This will be described in detail with reference to FIG. 6 below.

In operation 303, the data management device may control to extract a specific key value that is to be browsed by a user from the packed bucket data.

The data management device may browse the user data based on the key value. That is, the data management device may browse the user data by browsing the key value corresponding to the user data.

The data management device may control the storage device to extract user data that is to be browsed by browsing the key value corresponding to the user data included in the packed bucket data based on a key value that is to be browsed.

The data management device may control the host terminal to transmit the specific key value that is to be browsed by the user from the packed bucket data to the storage device, and the storage device may receive the specific key value that is to be browsed by the user and extract the specific key value.

Extracting, that is, an operation of browsing the specific key value that is to be browsed by the user may mean an operation of comparing the specific key value that is to be browsed with a stored key value, determining whether the specific key value and the stored key value are the same, and reading the user data or the key value, and may include a filtering operation.

The data management device may compare the tag information included in the offset filter with the specific key value that is to be browsed. Further, the data management device may also compare the key value corresponding to the user data included in the packed bucket data and the key value that is to be browsed based on a comparison result of the comparing of the tag information and the specific key value.

In operation 305, the data management device may exchange the specific key value through a smart interface.

For example, the data management device may control the host terminal to transmit the specific key value through the smart interface, and the storage device may receive the specific key value through the smart interface.

The smart interface may mean an operation of transceiving storage device related information, such as the key value, the user data, control information, and erasure unit information based on an API provided by the data management device.

That is, the host terminal and the storage device may transceive the user data, data of the key value, the control information, etc. through the smart interface.

The data management device may exchange the key value based on the parallel unit information that is the information regarding the size of data that may be parallel-processed in the storage device.

In addition, according to an embodiment, the data management device may acquire various types of information regarding the storage device through the smart interface. For example, the data management device may receive at least one of erase unit information of a size used to erase the data of the storage device, the parallel unit information regarding the size of data that may be parallel-processed in the storage device, address information of a region in which a current data write operation is performed and a region in which a data write operation is to be performed after the current data write operation, and region identification information regarding the number identifying regions that store the data by the storage device, from the storage device.

The data management device may acquire the various types of information from the storage device and transmit control information for controlling the storage device based on the acquired information to the storage device.

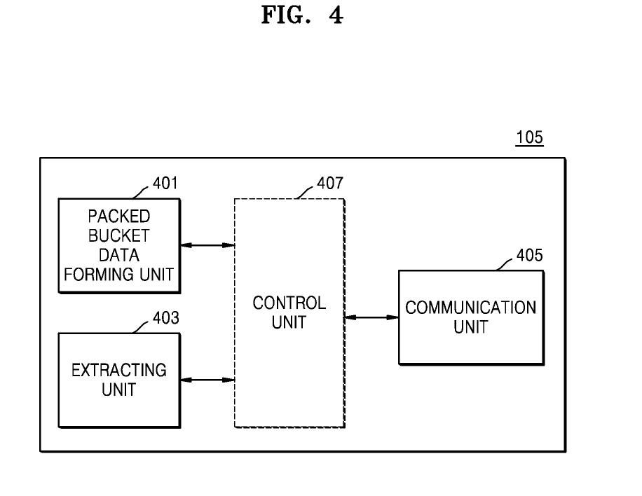

FIG. 4 illustrates a block diagram for explaining the controller 105 of a host terminal according to an example embodiment.

According to an embodiment, the controller 105 of the host terminal may include a packed bucket data forming unit 401 and an extracting unit 403.

The packed bucket data forming unit 401 may form packed bucket data by packing a user data and a pointing map indicating a storage location of the user data. That is, the packing of the user data and pointing map involves the packed bucket data forming unit 401 controlling a storage device to form and store the packed bucket data.

The packed bucket data forming unit 401 may store first user data in a bucket of a region allocated by a data management device based on information corresponding to a key value of the first user data, such as the pointing map.

For example, the user data includes user data sets, such as the first user data and second user data, and the pointing map includes index information of the user data and information indicating a location of the user data, and thus the packed bucket data forming unit 401 may form the packed bucket data by packing the first user data and the second user data stored in the storage device based on information included in the pointing map.

The packed bucket data forming unit 401 may store each piece of information stored in the pointing map, along with the user data sets, in the respective bucket, based on the index information.

The packed bucket data forming unit 401 may allocate a second region including one or more buckets for rearranging user data stored in a first region. In addition, the packed bucket data forming unit 401 may also allocate the first region. The second region allocated by the packed bucket data forming unit 401 may include a region different from the first region. The second region may be a continuous region.

That is, as described with reference to FIG. 3 above, the packed bucket data forming unit 401 may rearrange one or more pieces of user data stored in the first region and store the rearranged user data in the bucket included in the second region allocated by the packed bucket data forming unit 401 based on index information that is generated according to a key value of each piece of the user data stored in the first region. The packed bucket data forming unit 401 may allocate a plurality of second regions, and a third region for rearranging user data stored in the plurality of second regions.

In addition, according to an embodiment, the packed bucket data forming unit 401 may determine and allocate sizes of the second regions based on erase unit information of a size used to erase data of the storage device.

For example, according to an embodiment, the storage device includes an SSD that erases data in a block unit, and thus the packed bucket data forming unit 401 may determine the sizes of the second regions based on a size of a block of the SSD. The block unit that the SSD uses to erase data may correspond to the erase unit information. In addition, allocation of a region may be performed by a region allocation unit (not shown) of the packed bucket data forming unit 401.

The packed bucket data forming unit 401 may determine buckets of the second regions based on the index information of the user data.

The packed bucket data forming unit 401 may select one of the buckets of the second regions based on a key value corresponding to the user data to rearrange one or more pieces of user data stored in the first region in the second regions. That is, as described with reference to FIG. 3 above, a bucket for rearranging the user data may be selected based on the index information corresponding to the user data.

One or more buckets of the second regions are regions that may store one or more pieces of user data having the same index information, and thus the packed bucket data forming unit 401 may determine buckets corresponding to the index information of the user data that is to be rearranged.

That is, according to an embodiment, the packed bucket data forming unit 401 may select the user data that is to be rearranged among the user data stored in the first region based on the pointing map, and select the bucket included in the second regions based on the index information of the selected user data. In addition, a bucket determining unit (not shown) of the packed bucket data forming unit 401 may determine the bucket to store the user data.

The packed bucket data forming unit 401 may store the user data in the bucket determined by the bucket determining unit (not shown). That is, the packed bucket data forming unit 401 may form the packed bucket data by reading and storing the user data stored in the first region in the buckets of the second regions. In addition, a storage control unit (not shown) of the packed bucket data forming unit 401 may store the user data in the one or more buckets of the second regions.

The packed bucket data forming unit 401 may further include an index information acquiring unit (not shown) that stores the one or more pieces of user data in the first region and acquires hash index information generated by using each key value included in the one or more pieces of user data stored in the first region and a hash function.

The packed bucket data forming unit 401 may store address information storing the user data in the pointing map based on the acquired hash index information. The packed bucket data forming unit 401 may read the user data from the first region based on address information stored in the pointing map and store the read user data in the bucket determined by the packed bucket data forming unit 401.

The packed bucket data forming unit 401 may erase the same user data as one or more user data stored in the second regions from the first region. That is, the packed bucket data forming unit 401 may erase the user data rearranged in the second regions from the first region. Address information of the user data rearranged in the second regions may be erased from the pointing map, thereby reducing a size of the pointing map.

The packed bucket data forming unit 401 may rearrange the user data included in the second regions in a third region. This will be described in more detail with reference to FIG. 6 below.

In addition, the packed bucket data forming unit 401 may include an offset filter generating unit (not shown) that generates an offset filter including tag information identifying the one or more pieces of user data stored in each bucket.

The packed bucket data forming unit 401 may further include a bucket information generating unit (not shown) that generates information regarding a size of the user data including the bucket and information regarding the address of the user data in the bucket.

The packed bucket data forming unit 401 may control a host terminal to provide packed bucket data information controlling to form packed bucket data to a storage device, and the storage device may receive control information, such as the packed bucket data, thereby processing the user data.

The extracting unit 403 may control to extract a specific key value that is to be browsed by a user.

The extracting unit 403 may browse the user data based on the key value. That is, the extracting unit 403 may browse a key value corresponding to the user data, thereby controlling to browse, read, and extract the user data that is to be browsed by the storage device.

The extracting unit 403 may control the storage device to extract the key value corresponding to the user data included in the packed bucket data based on the key value that is to be browsed, thereby determining whether to include the user data that is to be browsed.

The extracting unit 403 may compare tag information included in the offset filter with the specific key value that is to be browsed. Further, the extracting unit 401 may compare the key value corresponding to the user data included in the packed bucket data with the key value that is to be browsed based on a comparison result of the comparing of the tag information with the specific key value. For example, if the comparison of the tag information in the offset filter with the specific key value that is to be browsed indicates a match, then the key value corresponding to the user data included in the packed bucket data is compared with the key value that is to be browsed.

The extracting unit 403 may control the host terminal to transmit the specific key value that is to be browsed by the user in the packed bucket data to the storage device, and the storage device may receive and browse the specific key value that is to be browsed by the user.

The controller 105 of the host terminal may further include a communication unit 405 that may exchange the specific key value through a smart interface.

The smart interface may mean an API provided by the data management device. That is, the smart interface is a function such as the API provided by the data management device so that the data management device and the storage device may transceive the user data, data of the key value, control information through the smart interface, and other data.

The communication unit 405 may exchange the key value based on parallel unit information that is information regarding a size of data that may be parallel-processed in the storage device.

In addition, the data management device may acquire various types of information regarding the storage device through the communication unit 405 by calling and executing a function such as the smart interface.

That is, the host terminal of the data management device may acquire at least one of erase unit information indicating a size used to erase the data of the storage device, the parallel unit information regarding the size of data that may be parallel-processed in the storage device, address information of a region in which a current data write operation is performed and a region in which a data write operation is to be performed after the current data write operation, and region identification information regarding the number identifying regions that store the data by the storage device. For example, the storage device may include an SSD.

Although the data management device may not use the smart interface, the communication unit 405 included in the controller 105 of the host terminal may acquire the various types of information from the storage device and transmit control information for controlling the storage device based on the acquired information to the storage device.

The communication unit 405 may exchange a key value based on the parallel unit information regarding the size of data that may be parallel-processed in the storage device acquired through the smart interface. That is, the controller 105 of the host terminal may receive the parallel unit information that is the information regarding the size of the data that may be efficiently stored and read from the storage device and transceive the key value based on the parallel unit information through the communication unit 405.

The communication unit 405 may control the host terminal to transmit a specific key value through the smart interface, and the storage device may receive the specific key value through the smart interface.

In addition, the controller 105 of the host terminal may include a control unit 407. In general, the control unit 407 may control a general operation of the controller 105 of the host terminal. That is, the control unit 407 may include a computation unit, such as a central control device, and may be included in another element. However, the present disclosure is not limited to this example.

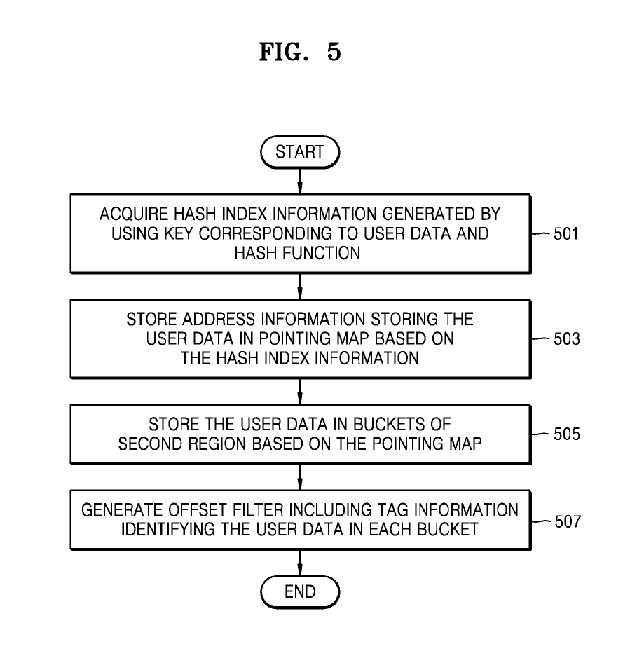

FIG. 5 is a detailed flowchart showing a method of managing data according to an example embodiment.

In operation 501, a data management device may acquire hash index information generated by using a key value corresponding to user data and a hash function.

The data management device may receive or acquire the user data that is to be stored in a storage device, store the user data in a first region, and acquire the hash index information of the user data stored in the first region by using the key value corresponding to the stored user data and the hash function.

The hash function may mean a function that expresses algorithm converting the key value as an equation so as to quickly retrieve the data. In addition, the hash index information may be a value obtained by applying a modulo function after converting the key value by using the hash function.

In operation 503, the data management device may store address information storing the user data in a pointing map based on the hash index information acquired in operation 501. This corresponds to the description provided with reference to FIG. 2 above. The pointing map may be a hash map that stores information regarding the user data but is not limited thereto, and may mean information itself regarding the stored user data.

In operation 505, the data management device may store the user data stored in the first region in buckets included in a second region based on the pointing map and address information of the pointing map.

The pointing map includes addresses storing the user data based on the hash index information, and thus the data storage device may acquire hash index information of user data that is to be stored in the second region from the pointing map. The data management device may determine a bucket of the second region that is to store the user data stored in the first region based on the hash index information, and may store the user data in the determined bucket of the second region.

In operation 507, the data management device may generate an offset filter including tag information identifying the user data stored in each bucket.

The offset filter may include tag information identifying the user data stored in each bucket of the second region and valid field information indicating whether information regarding the user data is included in a respective bucket. The offset filter may include information corresponding to the user data in each bucket.

Each bucket may include a plurality of data sets, such as first user data and second user data, and the offset filter may include information corresponding to the first user data and the second user data.

In addition, the data management device may erase the same user data as the user data stored in the second region from the first region, for example, when the rearranged user data of the first region is stored in the second region.

The data management device may rearrange the user data randomly stored in the first region based on index information, such as the hash index information. The completely rearranged user data is not necessarily stored repeatedly, and thus the data management device may erase the completely rearranged user data from the first region.

The data management device may erase address information of the user data erased from the first region from the pointing map.

If the used data stored in the first region is erased, since the address information of the user data stored in the pointing map is also unnecessary, the data management device may erase the address information of the erased user data from the pointing map, thereby reducing the size of the pointing map.

That is, a large region that is to be used as the pointing map is not necessarily allocated in a volatile memory of a host terminal, and operations 501 through 507 are used when the data is stored in more than a predetermined part of the region used as the pointing map, thereby efficiently managing the data.

In addition, the data management device may not store the user data in the first region and may store the user data in the buckets of the second region based on the key value corresponding to the user data and the index information. That is, the user data stored in the first region may not be rearranged but may be classified and stored in the buckets of the second region from the beginning.

FIG. 6 is a flowchart showing a method of managing data according to another example embodiment.

A data management device may rearrange user data stored in a first region in a second region as described with reference to FIGS. 2 through 5 above. The data management device may browse an offset filter when browsing the user data rearranged in the second region, thereby browsing the user data that is to be read.

However, when a plurality of second regions are allocated by performing the operations of FIG. 3 or 5, the data management device may rearrange user data stored in the second regions in a third region so as to more quickly browse the user data.

In operation 601, the data management device may allocate the third region that rearranges the user data included in the second regions.

The third region may be a region different from the first region and the second region, and may be greater in size than the second region. The third region may be a continuous region.

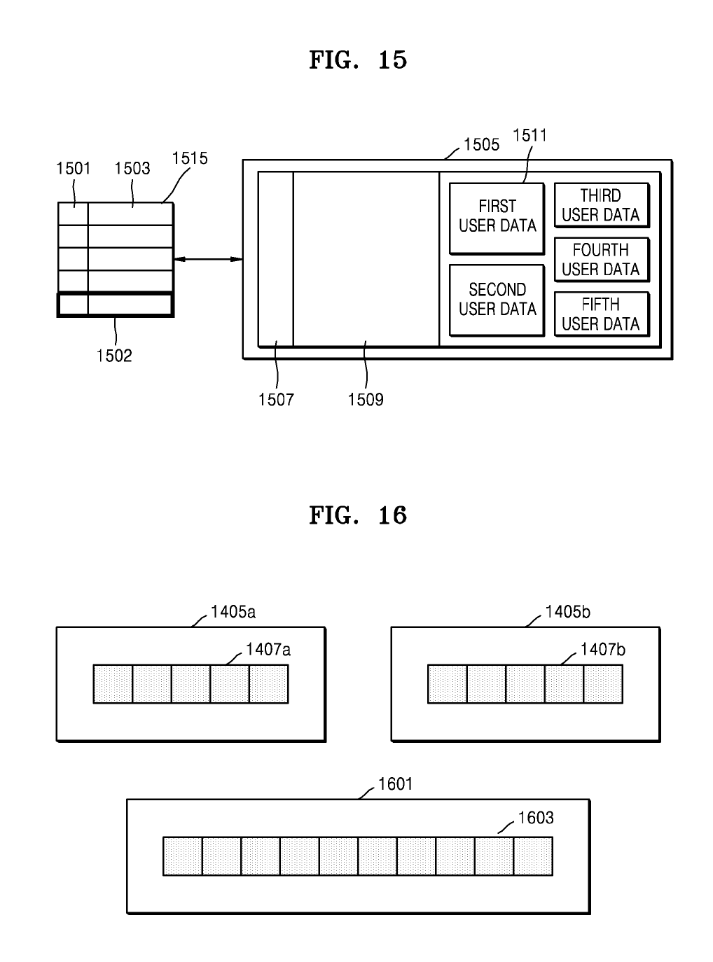

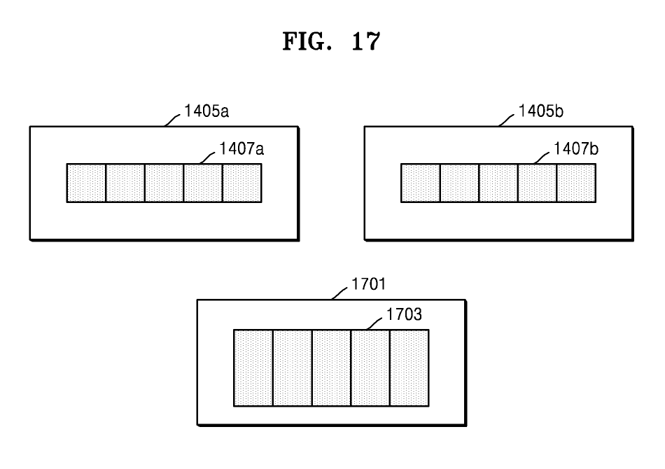

The third region may include one or more buckets each storing user data having the same index information. A size of each bucket included in the third region may be a predetermined multiple of a size of each bucket included in the second region. In addition, the number of buckets included in the third region may be the predetermined multiple of the number of the buckets included in the second region. This will be described in more detail with reference to FIGS. 16 and 17 above.

In operation 603, the data management device may rearrange the user data included in the second region in the third region based on a key value corresponding to the user data included in the second region.

The user data may be classified and stored in each bucket included in the second region with respect to index information based on the key value corresponding to the user data. Thus, the data management device may acquire the index information of the user data stored in each bucket included in the second region. In addition, the data management device may acquire the index information by acquiring the key value corresponding to the user data.

The data management device may store one or more pieces of user data stored in the plurality of second regions in one or more buckets included in the third region with respect to the index information.

For example, a size of each bucket included in the third region may be a predetermined multiple of the size of each bucket included in the second regions. That is, for example, if the size of each bucket included in the plurality of second regions is a size that may store 5 user data sets, the size of each bucket included in the third region may be a size that may store 10 user data sets. Thus, the third region may rearrange and store the user data stored in two second regions.

The number of the buckets included in the third region may be a predetermined multiple the number of the buckets included in the plurality of second regions. For example, if the second regions include 10 buckets, the third region may include 20 buckets. The size of each bucket stored in the second and third regions may be the same or may be a predetermined multiplication, depending on embodiments.

In operation 605, the data management device may erase the same user data as the user data stored in the third region from the plurality of second regions.

The data management device may erase the user data included in the plurality of second regions that are completely rearranged. The data management device may also erase an offset filter regarding each bucket of the second regions erased from the second regions.

In addition, the data management device may generate the offset filter regarding each bucket of the third region. The offset filter regarding each bucket of the third region may be newly generated or may be generated in combination with the offset filter regarding each bucket of the second regions.

The third region may be allocated based on erase unit information of a storage device and according to a property of the user data. In addition, the data management device may store the user data based on parallel processing information. This is the same as described with reference to FIGS. 2 through 4 above.

When regions are allocated based on the erase unit information, data stored in each respective region may be erased at the same time, and thus a garbage collection that reduces efficiency of a flash memory may not occur. For the sake of brevity, a detailed description of the garbage collection is omitted.

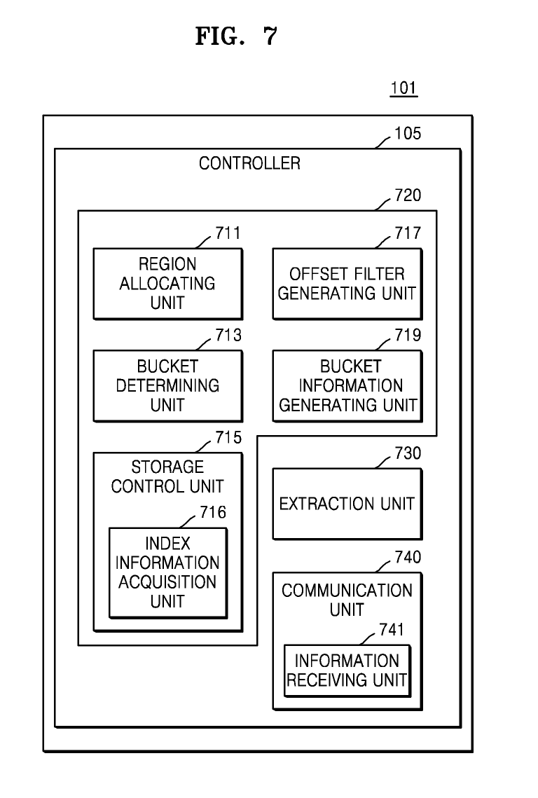

FIG. 7 illustrates a block diagram for explaining the host terminal 101 according to an example embodiment.

According to an embodiment, the host terminal 101 of FIG. 7 may be a host terminal corresponding to that of FIGS. 1 and 5.

The host terminal 101 may include the controller 105. Further, the controller 105 may be an element generally managing input/output of data and may include at least a packed bucket data forming unit 720, an extraction unit 730, and a communication unit 740.

The packed bucket data forming unit 720 may include at least a region allocating unit 711, a bucket determining unit 713, a storage control unit 715, an offset filter generating unit 717, and a bucket information generating unit 719.

The region allocating unit 711 may determine a region that stores data, such as the user data. That is, the region allocating unit 711 may control to separate and allocate regions of a storage device that stores the user data.

The bucket determining unit 713 may determine a bucket storing the user data. The bucket determining unit 713 may determine one of one or more buckets included in the regions allocated by the region allocating unit 711 to store the user data based on index information of the user data.

The storage control unit 715 may read user data stored in a first region and store the read user data in the bucket included in a second region determined by the bucket determining unit 713. That is, the storage control unit 715 may rearrange the user data stored in the first region, and store the rearranged user data in the second region.

The storage control unit 715 may include an index information acquisition unit 716. For example, the index information acquisition unit 716 may acquire index information corresponding to the user data stored in the storage device.

The index information may include hash index information. That is, the index information may refer to information obtained by converting key values corresponding to the user data by using a hash function, and may additionally refer to values obtained by processing the information by converting the key values using the hash function by using, for example, a modulo function.

The storage control unit 715 may store address information storing the user data in a pointing map based on the index information acquired by the index information acquiring unit 716. The pointing map may store tag information identifying the user data with respect to the index information and the address information.

The offset filter generating unit 717 may generate an offset filter including the tag information identifying the user data stored in the buckets and a valid field determining whether each piece of data is stored in an entry of the offset filter. The offset filter may correspond to the user data stored in the buckets.

The bucket information generating unit 719 may acquire address information of the user data stored in the first region and may generate address information in a manner that the address information may be stored in the pointing map. In addition, the bucket information generating unit 719 may generate bucket information including information regarding a location of the user data in the bucket and information indicating the number of user data sets included in the buckets.

The extraction unit 730 may extract a specific key value that is to be browsed by a user in packed bucket data. That is, the extraction unit 730 may browse the user data by extracting key values corresponding to the user data based on the key value that is to be browsed.

The extracting unit 730 may compare the tag information included in the offset filter with the specific key value that is to be browsed and may then compare the key values corresponding to the user data included in the packed bucket data with the specific key value that is to be browsed based on a comparison result of the comparison between the tag information and the specific key value.

The communication unit 740 may provide the command language or control information for controlling the storage device.

In addition, the communication unit 740 may include an information receiving unit 741 that acquires every piece of information received from the storage device, such as erase unit information, parallel unit information, storage unit information, address information, etc. from the storage device.

The host terminal 101 may include a control unit (not shown). In general, the control unit may control a general operation of the host terminal 101. That is, the control unit may include a computation unit, such as a central control device, and may be included in another element but is not limited thereto.

The host terminal 101 may include a volatile memory (not shown). The volatile memory may correspond to the volatile memory 103 of FIG. 1.

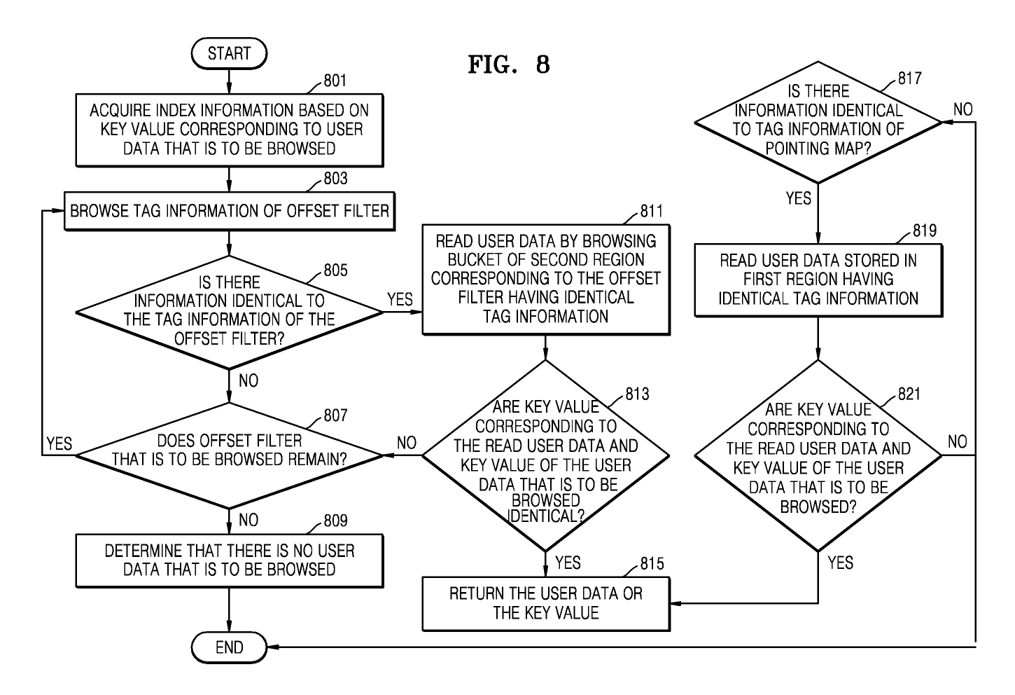

FIG. 8 is a flowchart showing a method of managing data according to another example embodiment.

The flowchart of FIG. 8 explains a method of browsing user data stored by using the methods described above with reference to at least FIGS. 2 through 7. That is, the flowchart of FIG. 8 explains a method in which a data management device browses the user data based on a specific key value.

In operation 801, the data management device may acquire index information based on a key value corresponding to user data that is to be explored. For example, the key value may be a phone number. Further, for example, the data management device may browse the phone number, that is, a key value, to explore the user data and may acquire index information of the user data that is to be browsed based on the key value.

The index information may be acquired by converting the key value using a hash function. The index information may include hash index information that is information obtained by converting the key value using the hash function.

In operation 803, the data management device may browse tag information of an offset filter. As described with reference to FIGS. 2 through 7, the data management device may rearrange the user data by allocating a second region and may generate the offset filter to quickly browse the user data stored in each of buckets included in the second region. Thus, the data management device may browse the offset filter to determine whether the user data is present in the second regions.

The tag information may be a part or portion of the key value. For example, when the key value is 10 bits, the tag information may be first through third bits. The data management device may determine whether user data that is be browsed is present by comparing the tag information of the offset filter and the key value that is to be browsed, or at least the portion (e.g., first through third bits) of the key value to be browsed.

When a plurality of second regions is present, a plurality of offset filters may also be present. The data management device may browse all the offset filters based on the index information and the key value.

In operation 805, the data management device may determine whether there is information identical to the tag information of the offset filter. That is, the data management device determines whether there is user data corresponding to the user data that is to be browsed by comparing the specific key value of the user data that is to be browsed and the tag information.

If there is no information identical to the tag information of the currently browsed offset filter, in operation 807, the data management device may determine whether there is a remaining offset filter that is to be browsed.

If there is no offset filter that is to be browsed remaining, in operation 809, the data management device may determine that there is no user data that is to be browsed and may end operations of browsing and reading the user data. In addition, when the data management device ends the operations, the data management device may transmit result information indicating that there is no user data that is to be browsed to a control unit of a host terminal or an output device.

Ending the operation of FIG. 8 may mean that the user data that is to be browsed is not present in the second region. In other words, when the user data is not stored or found in the second region, the data management device may additionally browse whether the user data is present in a first region like operations 817 through 821.

When there is information identical to the tag information of the offset filter, in operation 811, the data management device may read the user data by browsing a bucket filter of the second region corresponding to a bucket filter having identical tag information.

In operation 813, the data management device may determine whether a key value corresponding to the user data read in operation 811 and the key value of the user data that is to be browsed are identical to each other. That is, the data management device may determine whether user data corresponding to the key value that is to be browsed is present in the read user data based on the tag information of the offset filter by comparing a specific key value of the user data that is to be browsed included in a bucket and entire key values corresponding to the read user data.

According to a determination result of operation 813, when the key value of the user data read in operation 811 and the key value of the user data that is to be browsed are identical to each other, the user data may be returned in operation 815. The data management device may transmit result information indicating that the read user data is present to the control unit of the host terminal or the output device.

According to a determination result of operation 813, when the key value of the user data read in operation 811 and the key value of the user data that is to be browsed are not identical to each other, the data management device may continue browsing the user data by determining whether there is a remaining offset filter that is to be browsed like operation 807.

The user data may be stored in the first region, and thus the data management device may browse tag information of a pointing map based on the index information.

In operation 817, the data management device may determine whether there is information identical to the tag information of the pointing map.

According to a determination result of operation 817, when tag information corresponding to the key value that is to be browsed is not present in one or more pieces of tag information of the pointing map, the user data that is to be browsed is not present in the user data stored in the first region, and thus the data management device may end the operations of browsing and reading the user data. In addition, when the data management device ends the operations, the data management device may transmit the result information indicating that there is no user data that is to be browsed to the control unit of the host terminal or the output device.

As an example, ending the operations according to a determination result of operation 817 may mean that the user data that is to be browsed is not present in the first region. In other words, when the user data is not stored in the first region, the data management device may additionally browse whether the user data is present in the second region like operations 803 through 815.

According to the determination result of operation 817, when the tag information corresponding to the key value that is to be browsed is present in the one or more pieces of tag information of the pointing map, the data management device may read the user data stored in the first region having identical tag information in operation 819. For example, address information of the user data stored in the first region is stored in the pointing map, and thus the data management device may read the user data based on the address information of the user data having the identical tag information.

In operation 821, the data management device may generally compare whether the key value of the user data that is to be browsed and the key value corresponding to the user data read in operation 819 are identical.

Based on a determination of operation 821, the data management device may return the user data like operation 815 or may determine whether the user data that is to be browsed is stored in the second region like operations 803 through 815.

The data management device may determine whether there is the user data that is to be browsed by finally comparing all key values based on the index information firstly and the tag information secondly.

Operations 801 through 815 and operations 801 and 817 through 821 may be simultaneously or sequentially performed. That is, according to an embodiment, the data management device may simultaneously or sequentially determine whether the user data that is to be browsed is present in the first region or in the second region.

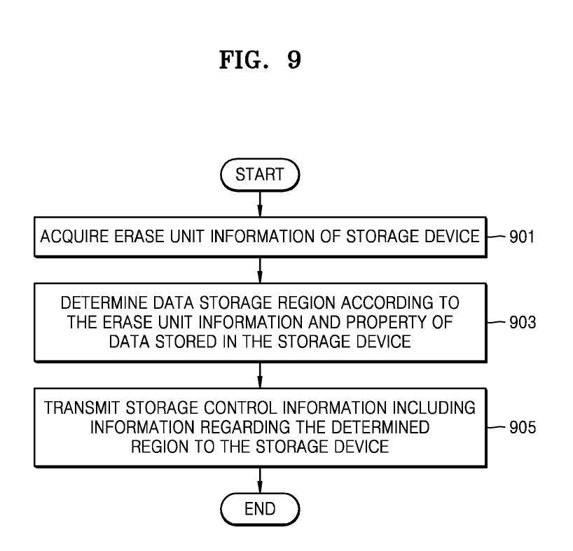

FIG. 9 is a flowchart showing a method of managing data according to another example embodiment.

A data management device stores and reads data according to storage and reading characteristics of a storage device, thereby efficiently managing the data. Data of FIGS. 9 through 18 may include user data.

The data management device may include an SSD including a flash memory. Data of the SSD is erased in a block unit that is a predetermined size. The data of the SSD is parallel-stored through a plurality of channels, and is not overwritten, and thus the SSD operates in a way that the data is primarily stored in an empty region. In addition, the SSD performs an operation of moving and erasing the data to another region, such as a garbage collection.

The characteristics of the storage device are different, and thus the data management device of the present embodiment provides an efficient data management method of acquiring information regarding the storage device and managing the data according to information regarding the storage device. In particular, according to an embodiment, the data management device provides a data management method according to the characteristics of the storage device.

In operation 901, the data management device may acquire erase unit information of the storage device. The erase unit information may be acquired from a controller, such as a smart interface unit of the storage device.

The erase unit information may be information indicating a minimum amount of data erased by the storage device and may have the same size as that of a block of the flash memory included in the storage device. According to an embodiment, the storage device may be the SSD including the flash memory. For example, a size of the block of the flash memory may be 128 MB or 256 MB, however, the present disclosure is not limited to this example. That is, the size of the block of the flash memory may be other sizes than described above.

In operation 903, the data management device may determine a data storage region according to the erase unit information acquired in operation 901 and a property of the data stored in the storage device.

The data management device may determine the data storage region based on the erase unit information. That is, the data management device may determine the data storage region so that the storage device may allocate a region storing each piece of data having the same size as the block unit that is a data erase unit.

The data management device may determine a region to store data stored in the storage device. The data management device may identify a logical region, thereby identifying the region to store the data stored in the storage device. That is, the data management device may identify the logical region, thereby determining the data storage region such that a physical region on the storage device is also identified when the data is stored.

Further, the logical region or an address may refer to information regarding a region and the address set to manage the data in a host terminal, and the physical region or an address may refer to a region or the address in which the data is actually stored in the storage device.

The property of the data may include a type of an application generating the data, a type of information included in the data, a size of the data, etc.

In addition, according to an embodiment, as shown in FIGS. 2 through 8, each region may be determined based on a method of storing the data. That is, a region storing the user data may be allocated to a first region based on a pointing map of FIG. 2, and a region for rearranging the user data stored in the first region may be allocated to a second region. Each region may be allocated based on the erase unit information acquired in operation 901.

In operation 905, the data management device may transmit storage control information including information regarding the data storage region determined in operation 903 to the storage device. The data management device may include and transmit information regarding the region to store the data in the storage device.

The storage device may identify regions storing the data based on storage control information to store the data. That is, the storage device may allocate a physical address of each region storing the data. That is, the storage control information may include information used to control the storage device to identify the regions storing the data and store the data.

The data management device may acquire parallel unit information of data sizes that may be parallel-processed by the storage device. According to an embodiment, the storage device includes an SSD that may perform operations of parallel-writing and parallel-reading data through a plurality of channels, thereby controlling the host terminal and the storage device to process the data based on the parallel unit information of the SSD so as to quicken the operations of writing and reading the data.

The data management device may acquire storage unit information, that is, information regarding a minimum unit storing the data in the storage device. The storage device includes the SSD that stores the data in pages of a block, and thus a size of each page may be a minimum unit storing the data. As such, the data management device may determine an amount of data that is to be stored or read at a time based on the storage unit information.

The data management device may acquire information regarding addresses of regions of the storage device in which a current data write operation is performed and another data write operation is to be performed after the current data write operation. That is, the data management device may acquire a physical address of the storage device and/or information regarding a logical address corresponding to the physical address.

The data management device may acquire region identification information regarding the number identifying the regions storing the data in the storage device. The region identification information may include information regarding how many regions the storage device may identify and allocate.

In addition, the data management device may change the data storage region determined in operation 903. The data management device may transmit updated storage control information including information regarding the changed region to the storage device.

The data management device may reset physical address information of the storage device that is performing the current write operation, thereby controlling the storage device to perform a data write operation on a block different from a block on which the current write operation is being performed. The data storage device may allocate a different physical block according to a type of the data. That is, the data management device may control to change a physical address used to store and read the data in the storage device.

The data management device may determine a size of a region in which the data is to be stored according to the erase unit information and additionally identify the region in which the data is to be stored according to a property of the data, thereby preventing fragmentation of the data. Further, the data management device may split each region and store the data, thereby storing and erasing the data without interference between virtual devices.

FIG. 10 illustrates a block diagram for explaining the controller 105 of a host terminal according to another example embodiment.

According to an embodiment, the controller 105 of the host terminal may include at least an information acquisition unit 1001, a region allocation unit 1003, and a storage control unit 1005.

In addition, the information acquisition unit 1001 may acquire at least one of erase unit information of a storage device, address information of a region in which data is stored, parallel unit information, storage unit information, and region identification information described with reference to FIG. 9. Information acquired from the storage device is not limited to the above, and all pieces of information regarding a computation unit of the storage device may be acquired. For example, the information acquisition unit 1001 may request the storage device to provide information regarding the storage device through an application programming interface (API)

The region allocation unit 1003 may allocate regions storing data based on a property of the data and the erase unit information acquired by the information acquisition unit 1001. This corresponds to the description provided with reference to FIG. 9. The region allocation unit 1003 of FIG. 10 may include an operation performed by the region allocation unit 711 of FIG. 7.

The storage control unit 1005 may transmit storage control information, that is, information regarding the regions allocated by the region allocation unit 1003 to the storage device. The storage control unit 1005 provides the storage control information to the storage device to control the storage device to allocate a region storing each piece of data according to the regions allocated by the region allocation unit 1003 and store each piece of data in the allocated region.

The storage control unit 1005 may determine an amount of the data that is to be stored or read at a time based on the parallel unit information and the storage unit information acquired by the information acquisition unit 1001.

The controller 105 of the host terminal may also include a control unit 1007. In general, the control unit 1007 may control a general operation of the controller 105 of the host terminal. That is, the control unit 1007 may include a computation unit, such as a central control device, and may be included in another element but is not limited thereto.

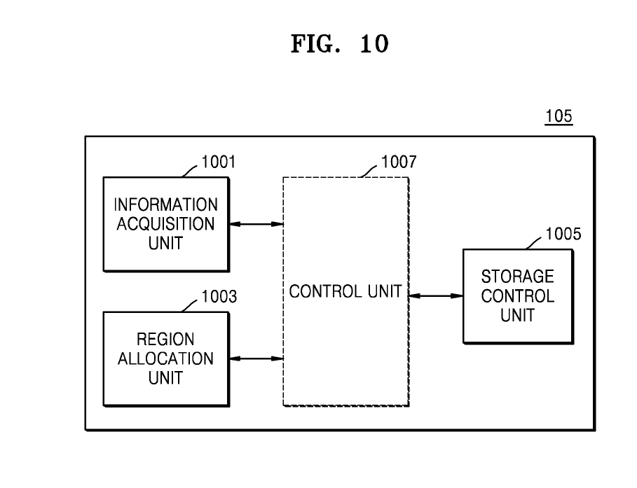

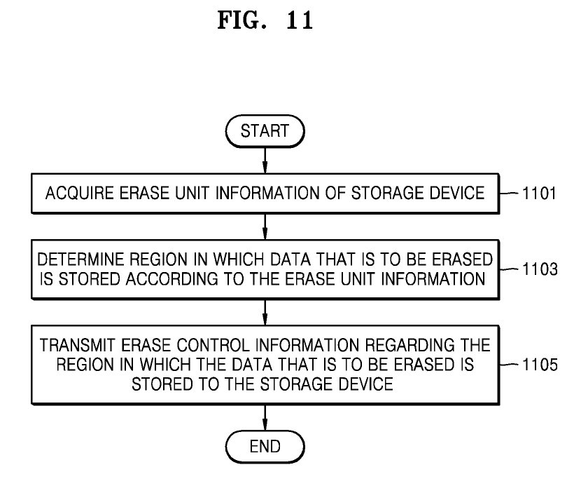

FIG. 11 is a flowchart showing a method of managing data according to another example embodiment.

In operation 1101, a data management device may acquire erase unit information of a storage device. This may correspond to operation 901 of FIG. 9.

In operation 1103, the data management device may determine a region in which data that is to be erased is stored based on the erase unit information acquired in operation 1101. For example, when a region in which data is stored is determined based on the erase unit information, the data management device may determine a region that is to be erased in a block unit. That is, the data management device may determine a continuous logical region as the region that is to be erased.

In operation 1105, the data management device may transmit erase control information, that is, information regarding the region in which the data that is to be erased is stored to the storage device. The storage device may identify and erase the region in which the data that is to be erased is stored based on the erase control information received from the data management device.

For example, the storage device may include an SSD. The SSD primarily stores the data in an empty space other than the block unit, while erasing the data in the block unit, and thus the SSD performs a garbage collection operation of copying data that is not erased but is included in a block that is to be erased to another block. However, according to an embodiment, the data is stored and erased based on the erase unit information of the SSD, and thus the garbage collection operation may be unnecessary.

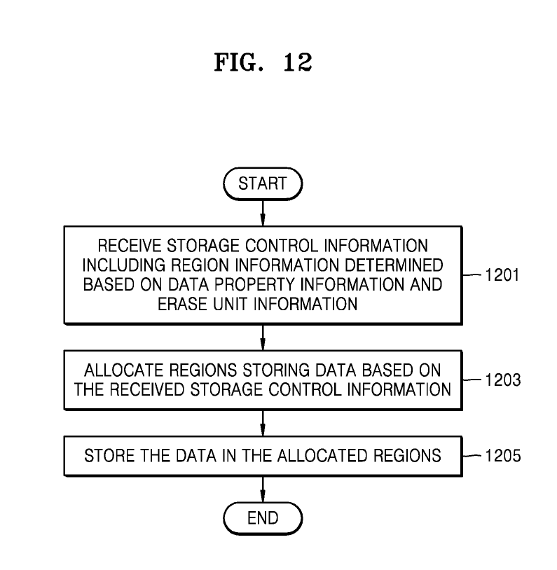

FIG. 12 is a flowchart showing a method of managing data according to another example embodiment.

In operation 1201, a data management device may receive storage control information including region information determined based on data property information and erase unit information.

Depending on embodiments, the data management device of FIG. 12 may be a controller included in a storage device. In an example embodiment, the data management device of FIG. 12 may correspond to the smart interface unit 109 of the storage device of FIG. 1. That is, the smart interface unit 109 of FIG. 1 may perform functions similar to the controller 105.

That is, the storage device may receive information regarding data that is to be stored, a region in which each piece of data is to be stored, and a size of the region in which each piece of data is to be stored.

In operation 1203, the data storage device may allocate regions storing the data based on the storage control information.

The data management device may allocate physical regions storing the data based on the storage control information. The storage control information may include only information regarding a logical region, and thus the data management device may allocate a physical region corresponding to the logical region.

In operation 1205, the data management device may store the data in the allocated regions.

In addition, the data management device may provide at least one of information regarding the storage device, such as erase unit information of the storage device, address information of the regions storing the data, parallel unit information, storage unit information, region identification information, etc. to a host terminal. According to an embodiment, the storage device may provide the information regarding the storage device according to a request of the host terminal. For example, the host terminal may request the information regarding the storage device through an API provided by the data management device.

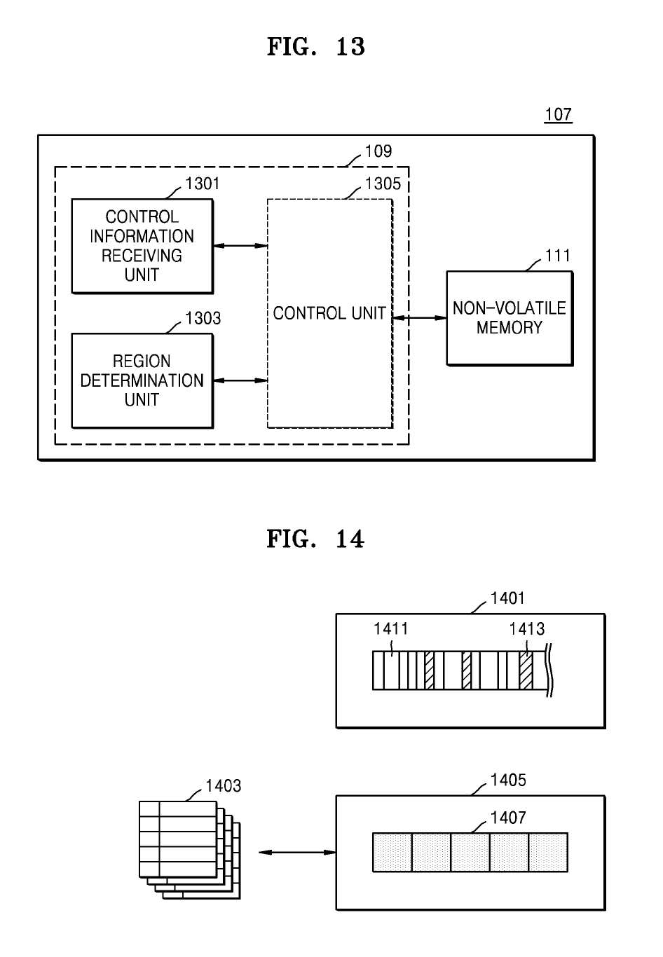

FIG. 13 illustrates a block diagram of the storage device 107 according to an example embodiment.

According to an embodiment, the storage device 107 may include at least the smart interface unit 109 and the non-volatile memory 111.

The smart interface unit 109 may act as a controller of the storage device 107, and perform various operations of storing and reading data according to a control of a data management device, receiving the data and control information from a host terminal, and transmitting the data.

The smart interface unit 109 of FIG. 13 may include at least a control information receiving unit 1301, a region determination unit 1303, and a control unit 1305.

The control information receiving unit 1301 may receive control information from the host terminal. The control information receiving unit 1301 may receive not only the control information but also information that is to be stored in the non-volatile memory 111 from the host terminal. A data receiving unit (not shown) other than the control information receiving unit 1301 may receive the data.

The control information receiving unit 1301 may receive the storage control information from the host terminal. The storage control information may include region information determined based on a property of the data and erase unit information, that is, information regarding a data erase size of the storage device 107.

The region determination unit 1303 may determine a region based on the storage control information received from the control information receiving unit 1301. This may correspond to the description provided with reference to FIG. 12 above. The region determination unit 1303 of the smart interface unit 109 may allocate the region based on a physical address of the storage device 107 using the information determined by the region allocation unit 1003 (see FIG. 10) of the host terminal.

According to an embodiment, the non-volatile memory 111 may store each piece of data in the allocated region.

In addition, the storage device 107 may include an information providing unit (not shown) that may provide at least one of erase unit information of the storage device 107, address information of a region in which the data is stored, parallel unit information, storage unit information, and region identification information. This may correspond to the description with reference to FIG. 12 above.

The control unit 1305 may control a general operation of the data management device of the storage device 107. That is, the control unit 1305 may include a computation unit, such as a central control device, and may be included in another element but is not limited thereto.

FIG. 14 illustrates a diagram for explaining a method of rearranging data according to an example embodiment.

Depending on embodiments, a data management device may be divided into a first region 1401 and a second region 1405 and may store user data.

The data management device may store the user data in the first region 1401. The data management device stores the user data stored in the first region 1401 into the second region 1405, after rearranging the user data stored in the first region. That is, the user data in the first region is rearranged and the rearranged user data of the first region is stored in the second region.

Referring to FIG. 14, for example, first user data 1411 stored in the first region 1401 may be rearranged in a bucket 1407 of the second region 1405 and may be erased from the first region 1401.

For example, when the storage device is an SSD, since the SSD performs an erase operation in a block unit, the user data rearranged from the first region 1401 to the second region 1405 may not be immediately erased. Invalid data is indicated like second user data 1413 indicated by a shaded area, and thus the SSD may perform the erase operation in the block unit in the future.

The bucket 1407 of the second region 1405 is continuous, and is allocated based on erase unit information, and thus user data stored in of the second region may be stored in a third region and then may be erased unlike the first region 1401. That is, the data management device may determine a region storing the user data based on the erase unit information.

The data management device may generate an offset filter 1403 corresponding to the bucket 1407 of the second region 1405. The offset filter 1403 corresponds to the user data included in the bucket 1407. This will be described in detail with reference to FIG. 15.

FIG. 15 illustrates a diagram for explaining structures of a bucket 1505 and an offset filter 1515 according to an example embodiment.

The offset filter 1515 includes information for browsing user data stored in the bucket 1505. The single bucket 1505 and the single offset filter 1515 may be mapped to each other.

The offset filter 1515 may include a valid bit field 1501 indicating whether data is stored in an entry 1502 of the offset filter 1515 and a tag information filter 1503 indicating tag information of the user data.

The single entry 1502 of the offset filter 1515 may include the single valid bit field 1501 and the single tag information filter 1503. For example, information stored in a first entry of an offset filter may correspond to first user data 1511 stored in the bucket 1505. Further, the first user data 1511 may mean one user data set included in the user data. As an example, the fifth user data of the bucket 1505 may corresponding to the entry 1502, which is the fifth entry in the offset filter 1515.

In addition, not only the user data but also additional information may be stored in the bucket 1505 such that the user data may be quickly browsed in the bucket 1505. The bucket 1505 may also include information 1507 regarding the number of user data sets stored in the bucket 1505 and address information 1509 of the user data included in the bucket 1505.

The address information 1509 of the user data included in the bucket 1505 is information for identifying continuously stored user data, and may refer to information used to determine which location the user data is stored in the bucket 1505.

FIG. 16 illustrates a diagram for explaining a method of rearranging data according to another example embodiment.

A data management device may rearrange user data stored in a plurality of second regions in a third region.

Referring to FIG. 16, for example, a plurality of second regions 1405a and 1405b may be regions allocated to rearrange user data stored in a first region like the second region 1405 of FIG. 14.

Further, the second region 1405a or 1405b may include at least one bucket 1407a or 1407b, respectively. A third region 1601 may include at least one bucket 1603.

The number of the buckets 1603 included in the third region 1601 may be a predetermined multiple of the number of the buckets 1407a and 1407b included in the plurality of second regions 1405a and 1405b. For example, second region 1407a has 5 buckets, and third region 1601 has 10 buckets. The present disclosure is not limited to this example, and other numbers of buckets may be used.

The data management device may rearrange user data stored in the second regions 1405a and 1405b into the at least one bucket 1603 included in the third region 1601. That is, the data management device may rearrange and store the user data stored in the second regions 1405a and 1405b in the at least one bucket 1603 of the third region 1601 based on index information.

The buckets 1407a, 1407b, and 1603 of FIG. 16 may have the same size. For example, the buckets 1407a, 1407b, and 1603 of FIG. 16 may be regions in which 10 user data sets or 50 KB at the maximum may be stored.

The data management device may distribute the user data in each of buckets stored in a region based on the number of the buckets and the index information. Referring to FIG. 16, the data management device may distribute the user data by using 2 bits of the index information of the user data in the buckets 1407a and 1407b of the second regions 1405a and 1405b. When the at least one bucket 1603 of the third region 1601 has the same size as those of the buckets 1407a and 1407b of the second regions 1405a and 1405b and the number of the at least one bucket 1603 of the third region 1601 is greater than that of the buckets 1407a and 1407b of the second regions 1405a and 1405b, the data management device may distribute the user data by using 3 bits of the index information of the user data in the at least one bucket 1603 of the third region 1601.

For example, user data having index information of 011 and 111 may be included in the same bucket of the second regions 1405a and 1405b, but included in different buckets when rearranged in the third region 1601.

FIG. 17 illustrates a diagram for explaining a method of rearranging data according to another example embodiment.

According to an embodiment, a data management device may rearrange at least one piece of user data stored in a plurality of second regions and store the rearranged user data in a third region.

In addition, the data management device may generate an offset filter identifying user data stored in the at least one bucket 1603 of the third region 1601 and may erase an offset filter identifying user data stored in the bucket 1407a or 1407b of the second region 1405a or 1405b.

Referring to FIG. 17, for example, the plurality of second regions 1405a and 1405b may be regions allocated to rearrange user data stored in a first region like the second region 1405 of FIG. 14.

The second region 1405a or 1405b may include the at least one bucket 1407a or 1407b. A third region 1701 may include at least one bucket 1703.

Referring to FIG. 17, the number of the buckets 1703 included in the third region 1701 may be the same as the number of the buckets 1407a and 1407b included in the second regions 1405a and 1405b. However, a size of the third region 1703 may be a predetermined multiple of sizes of the second regions 1405a and 1405b. For example, the number of the buckets 1407a, 1407b, and 1703 of the second and third regions 1405a, 1405b, and 1701 of FIG. 17 may be 5. In addition, according to an example embodiment, the second region 1405a or 1405b may each have a size of 128 MB, and a size of the third region 1701 may be 256 MB. Further, a size of the bucket 1703 included in the third region 1701 may be a predetermined multiple of a size of the bucket 1407a or 1407b of the second region 1405a or 1405b. For example, the size of the bucket 1407a or 1407b of the second region 1405a or 1405b may be 50 KB, and the size of the bucket 1703 included in the third region 1701 may be 100 KB. The sizes of the buckets described above are exemplary, and thus, the present disclosure is not limited thereto.

The data management device may rearrange user data in each of buckets stored in a region based on the number of the buckets and index information. Referring to FIG. 17, the data management device may store user data stored in a first bucket of each of the second regions 1405a and 1405b in a first bucket stored in the third region 1701.

That is, the data management device may rearrange the user data in the third region 1701 in the same manner as the user data is distributed in the second regions 1405a and 1405b. The size of the bucket 1703 included in the third region 1701 may be greater than that of the bucket 1407a or 1407b of the second region 1405a or 1405b, and thus the user data stored in the second regions 1405a and 1405b may be rearranged in the single third region 1701. The number of user data stored in the at least one bucket 1703 of the third region 1701 may be greater than that of user data stored in the bucket 1407a or 1407b of the second region 1405a or 1405b.

For example, both first user data stored in a first bucket of the second region 1405a and second user data stored in a first bucket of the second region 1405b may be stored in a first bucket of the third region 1701.

In addition, the data management device may generate an offset filter identifying user data stored in the at least one bucket 1703 of the third region 1701 and may erase an offset filter identifying user data stored in the bucket 1407a or 1407b of the second region 1405a or 1405b.

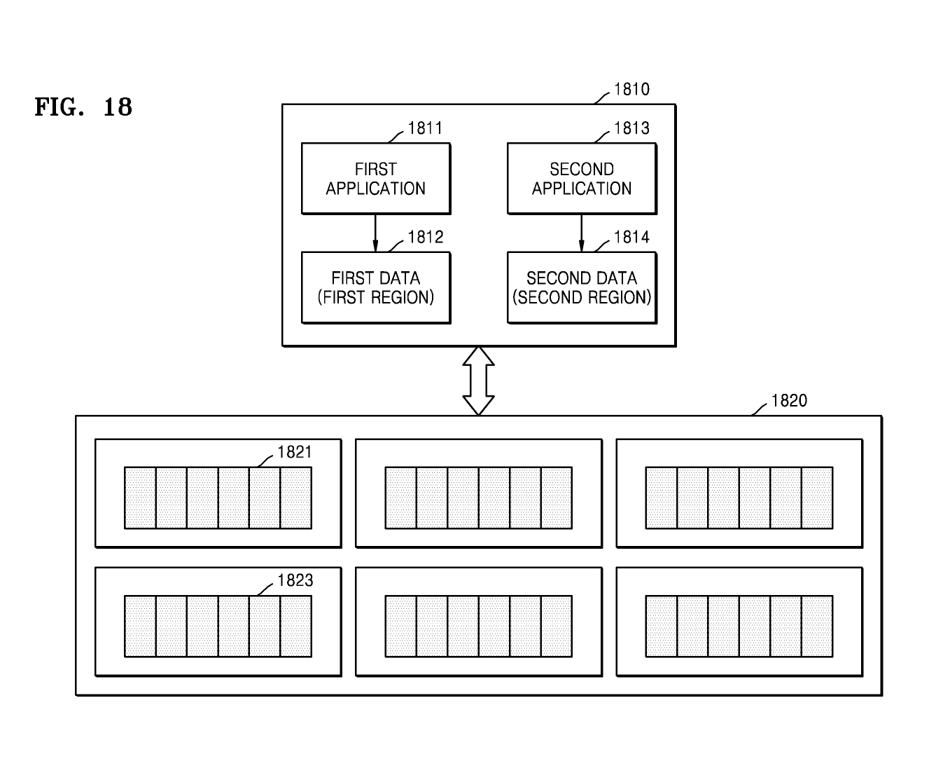

FIG. 18 illustrates a diagram for explaining a method of allocating data storage regions according to an example embodiment.

A data management device may determine regions to store data according to properties of data.

Referring to FIG. 18, one or more applications 1811 and 1813 included in a host terminal 1810 may generate first data 1812 and second data 1814. The data management device may determine that the first data 1812 is stored in a first region and the second data 1814 is stored in a second region. Further, the host terminal 1810 may determine a logical region in which data is to be stored according to a property of the data.

In addition, a storage device 1820 may allocate a region to store each piece of data based on storage control information identifying the regions to store the data received from the host terminal 1810. That is, the storage device 1820 may store the first data 1812 in a first region 1821 and the second data 1814 in a second region 1823. The storage device 1820 may determine a physical region in which the data is to be stored according to a control of the host terminal 1810. Depending on embodiments, the logical region and the physical region may be different.

In addition, the data management device of the host terminal 1810 may determine the regions to store the data based on erase unit information of the storage device 1820. That is, the data management device of the host terminal 1810 may determine sizes of the regions to store the data based on the erase unit information of the storage device 1820.

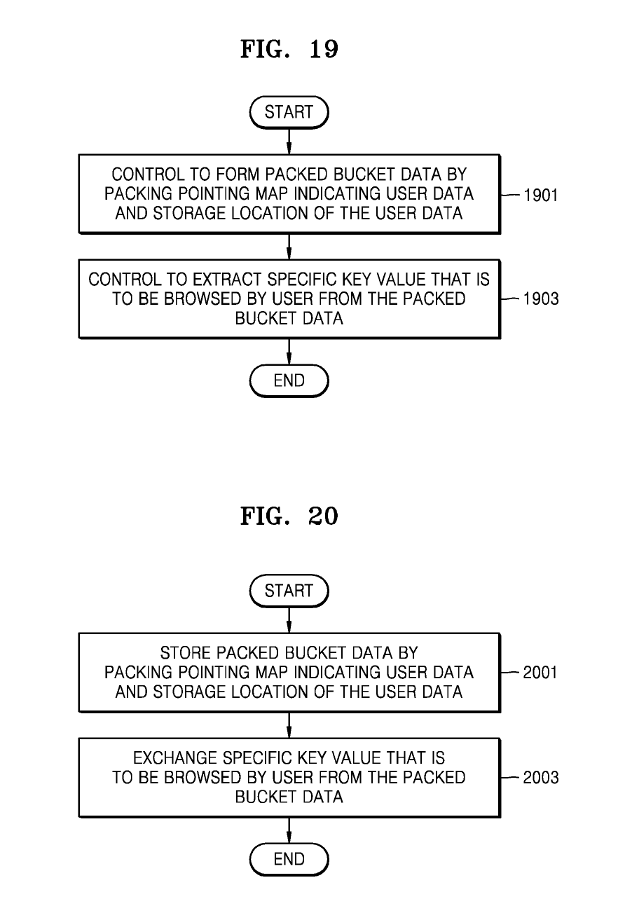

FIG. 19 is a flowchart showing a data management method performed by a host terminal according to an example embodiment.

According to an embodiment, a data management device may include the host terminal and a storage device. Further, as an example, the data management device may include a server.

In operation 1901, the host terminal may form packed bucket data by packing a user data and a pointing map indicating a storage location of the user data.

That is, the host terminal may control the storage device to form the packed bucket data by rearranging the user data based on a key value corresponding to the user data in a region including one or more buckets of the storage device.

The host terminal may allocate a second region including one or more buckets rearranging user data stored in a first region of the storage device. That is, the host terminal may control data to be stored in a specific region of the storage device.

In addition, the host terminal may acquire at least one of information regarding the storage device, such as at least erase unit information of a size used to erase the data of the storage device, parallel unit information regarding a size of data that may be parallel-processed in the storage device, information regarding an address of a region in which a current data write operation is performed and an address of a region in which a data write operation is to be performed after the current data write operation, storage unit information regarding a minimum unit storing the data in the storage device, and region identification information regarding the number identifying regions that store the data in the storage device, from the storage device. Further, the host terminal may allocate the second region based on the information regarding the storage device and a property of the user data.

The host terminal may determine a bucket of the second region and control the storage device to store the packed bucket data including the user data in the determined bucket.

The host terminal may generate information regarding a size of the user data included in the bucket and information regarding an address of the user data in the bucket. The host terminal may store the information regarding the size of the user data and the information regarding the address of the user data in the bucket.

That is, the host terminal may transmit the information regarding the size of the user data and the information regarding the address of the user data that are stored in the bucket to the storage device and may control the storage device to store the information regarding the size of the user data and the information regarding the address of the user data in the bucket.

Further, the host terminal may allocate a third region rearranging user data included in a plurality of second regions. That is, the host terminal may control to store the data in a specific region of the storage device. The host terminal may rearrange and store the user data included in the second regions into the third region and may erase the user data stored in the second regions that is the same as the user data stored in the third region. That is, the host terminal may rearrange the user data included in the second regions in the third region and may control the storage device to erase the user data stored in the second regions that is the same as the user data stored in the third region.

The host terminal may store the packed bucket data in the storage device based on the parallel unit information. That is, the host terminal may control the storage device to store the packed bucket data based on the parallel unit information.

In addition, the host terminal may generate an offset filter including tag information identifying the user data of the packed bucket data based on a key value corresponding to the user data and hash index information generated by using a hash function.

In operation 1903, the host terminal may control to extract a specific key value that is to be browsed by a user from the packed bucket data.

The host terminal may compare the tag information of the offset filter and the specific key value that is to be browsed, and may additionally compare a key value corresponding to user data of the packed bucket data and the specific key value that is to be browsed based on a comparison result of the tag information with the specific key value.

The host terminal may transmit control information controlling to store and read the data to the storage device based on the at least one information regarding the storage device received from the storage device.

In addition, the host terminal may acquire the at least one information regarding the storage device through a smart interface from the storage device and may exchange the storage device and the key value based on the acquired information regarding the storage device.

FIG. 20 is a flowchart showing a data management method performed by a storage device according to an example embodiment.

In operation 2001, the storage device may store user data and packed bucket data formed by packing a pointing map indicating a storage location of the user data.

The storage device may receive control information storing the packed bucket data from a host terminal and may store the packed bucket data in a bucket based on the received control information.

In addition, the storage device and the host terminal may exchange a specific key value that is to be browsed by a user. That is, the storage device may transmit the user data read from the storage device or a key value to the host terminal, and the host terminal may transmit the key value that is to be browsed or the user data to the storage device.

The storage device may provide one of information regarding the storage device, such as erase unit information, parallel unit information, address information of a region in which a data write operation is to be performed, storage unit information, and region identification information to the host terminal. This may correspond to the descriptions provided with reference to FIGS. 1 through 19.

An apparatus described herein may include a processor, a memory for storing program data and executing it, a permanent storage, such as a disk drive, a communications port for handling communications with external devices, and user interface devices, including a display, keys, etc. When software modules are involved, these software modules may be stored as program instructions or computer-readable codes executable on the processor on a computer-readable media, such as read-only memory (ROM), random-access memory (RAM), CD-ROMs, magnetic tapes, floppy disks, and optical data storage devices. The computer-readable recording medium may also be distributed over network coupled computer systems so that the computer-readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the inventive concept, reference has been made to the exemplary embodiments illustrated in the drawings, and specific language has been used to describe these embodiments. However, no limitation of the scope of the inventive concept is intended by this specific language, and the inventive concept should be construed to encompass all embodiments that would normally occur to one of ordinary skill in the art.

The exemplary embodiments may be described in terms of functional block components and various processing steps. Such functional blocks may be realized by any number of hardware and/or software components configured to perform the specified functions. For example, the exemplary embodiments may employ various integrated circuit components, e.g., memory elements, processing elements, logic elements, look-up tables, and the like, which may carry out a variety of functions under the control of one or more microprocessors or other control devices. Similarly, where the elements of the exemplary embodiments are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the exemplary embodiments may employ any number of general techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the inventive concept and are not intended to otherwise limit the scope of the inventive concept in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the inventive concept (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the inventive concept and does not pose a limitation on the scope of the inventive concept unless otherwise claimed. Numerous modifications and adaptations will be readily apparent to those of ordinary skill in this art without departing from the spirit and scope of the inventive concept.

What is claimed is:

1. A method of managing data, the method comprising:
forming, by a controller, packed bucket data by packing user data and a pointing map indicating a storage location of the user data;
extracting a specific key value that is to be browsed by a user from the packed bucket data; and
exchanging the specific key value using a smart interface.

2. The method of claim 1, wherein the pointing map comprises information indicating the storage location of the user data based on a key value corresponding to the user data and hash index information generated by using a hash function.

3. The method of claim 2, wherein the pointing map further comprises a valid display field indicating information regarding whether an entry of the pointing map is empty, and a tag field to store a portion of the key value corresponding to the user data.

4. The method of claim 3, wherein the tag field of the pointing map is compared with the specific key value before the stored user data is read.

5. The method of claim 1, wherein the forming the packed bucket data comprises:
generating an offset filter comprising tag information identifying the user data of the packed bucket data based on a key value corresponding to the user data and hash index information generated by using a hash function.

6. The method of claim 5, wherein the extracting of the specific key value comprises:
comparing the tag information of the offset filter and the specific key value that is to be browsed; and
comparing the key value corresponding to the user data of the packed bucket data and the specific key value that is to be browsed based on a comparison result of the comparing of the tag information and the specific key value.

7. The method of claim 6, wherein the extracting comprises:
determining whether user data that is to be browsed is stored in a first region of a storage device, and simultaneously determining whether the user data that is to be browsed is stored in a second region of the storage device.

8. The method of claim 6, wherein the extracting comprises:
determining whether user data that is to be browsed is stored in a first region of a storage device, and sequentially determining whether the user data that is to be browsed is stored in a second region of the storage device.

9. The method of claim 1, wherein the exchanging comprises: exchanging the specific key value based on parallel unit information regarding a size of data acquired using the smart interface that may be parallel-processed in a storage device.

10. The method of claim 1, wherein the forming of the packed bucket data comprises:
allocating a second region comprising one or more buckets;
rearranging user data stored in a first region based on a key value corresponding to the user data;
determining a bucket of the second region for storing the rearranged user data; and
storing the packed bucket data comprising the user data in the determined the bucket.

11. The method of claim 10, wherein the forming the packed bucket data comprises:
generating information regarding a size of the user data included in the bucket and information regarding an address of the user data included in the bucket; and
storing, in the bucket, the information regarding the size of the user data and the information regarding the address of the user data.

12. The method of claim 10, wherein the forming the packed bucket data comprises:
allocating a third region comprising one or more buckets; and
rearranging the user data included in the second region, and storing the rearranged user data of the second region in the third region based on a key value corresponding to the user data included in the second region.

13. The method of claim 12, wherein a size of the third region is a predetermined multiple of a size of the second region.

14. The method of claim 10, wherein the forming the packed bucket data comprises:
erasing the user data stored in the second region that is the same as the user data stored in the third region.

15. The method of claim 12, wherein the allocating the third region comprises:
allocating at least one of the first region, the second region, and the third region based on erase unit information regarding a size used to erase data of a storage device.

16. The method of claim 10, wherein the storing the packed bucket data comprises:
storing the packed bucket data based on parallel unit information regarding a size of data that may be parallel-processed in the storage device.

17. The method of claim 10, wherein the allocating the second region comprises:
allocating the second region based on region information determined based on a property of the user data.

18. The method of claim 1, further comprising:
acquiring information regarding a storage device, the information comprising at least one of erase unit information of a size used to erase data of the storage device, parallel unit information regarding a size of data that may be parallel-processed in the storage device, information regarding an address of a region in which a current data write operation is performed and an address of a region in which a data write operation is to be performed after the current data write operation, storage unit information regarding a minimum unit storing the data in the storage device, and region identification information regarding the number identifying regions that store the data in the storage device.

19. The method of claim 18, further comprising: transmitting control information controlling to store and read data of the storage device based on the acquired information regarding the storage device.

20. An apparatus for managing data, the apparatus comprising:
a host terminal comprising a packed bucket data forming unit to form packed bucket data by packing user data and a pointing map indicating a storage location of the user data, and an extraction unit to extract a specific key value that is to be browsed by a user from the packed bucket data; and
a storage device to store the user data and the packed bucket data and receive the specific key value from the host terminal.

21. The apparatus of claim 20, wherein the pointing map comprises information indicating the storage location of the user data based on a key value corresponding to the user data and hash index information generated by using a hash function.

22. The apparatus of claim 21, further comprising a memory included in the host terminal to store the pointing map,
wherein when a portion of the memory storing the pointing map exceeds a predetermined percentage of a total capacity of the memory, the host terminal performs the packing of the user data and the pointing map into the packed bucket data, and erases the storage location of the user data from the pointing map, thereby reducing an amount of data stored in the memory.

23. The apparatus of claim 20, wherein the packed bucket data forming unit comprises an offset filter generation unit to generate an offset filter comprising tag information identifying the user data of the packed bucket data based on a key value corresponding to the user data and hash index information generated by using a hash function.

24. The apparatus of claim 23, wherein the extraction unit compares the tag information of the offset filter and the specific key value that is to be browsed, and compares the key value corresponding to the user data of the packed bucket data and the specific key value that is to be browsed based on a comparison result of the compared tag information and the specific key value.

25. The apparatus of claim 20, wherein the host terminal further comprises: a communication unit for exchanging the specific key value through a smart interface,
wherein the communication unit exchanges the key value based on parallel unit information regarding a size of data acquired through the smart interface that may be parallel-processed in a storage device.

26. The apparatus of claim 20, wherein the packed bucket data forming unit comprises:
a region allocation unit to allocate a second region of the storage device comprising one or more buckets;
a bucket determination unit to determine a bucket in the second region to store the user data ; and
a storage control unit to rearrange the user data stored in the first region, and to store the rearranged user data of the first region in the determined bucket in the second region.

27. The apparatus of claim 26, wherein the packed bucket data forming unit comprises: a bucket information generation unit to generate information regarding a size of the user data included in the bucket and information regarding an address of the user data included in the bucket,
wherein the storage control unit stores, in the bucket, the information regarding the size of the user data and the information regarding the address of the user data.

28. The apparatus of claim 26, wherein the region allocation unit allocates a third region comprising one or more buckets, wherein the storage control unit rearranges the user data included in the plurality of second regions and stores the rearranged user data of the second region in the third region based on a key value corresponding to the user data included in the plurality of second regions.

29. The apparatus of claim 28, wherein a size of the third region is a predetermined multiple of sizes of the plurality of second regions.

30. The apparatus of claim 26, wherein the storage control unit erases the user data stored in the second region that is the same as the user data stored in the third region.

31. The apparatus of claim 28, wherein the region allocation unit allocates at least one of the first region, the second region, and the third region based on erase unit information regarding a size used to erase data of the storage device.

32. The apparatus of claim 26, wherein the storage control unit stores the packed bucket data based on parallel unit information regarding a size of data that may be parallel-processed in the storage device.

33. The apparatus of claim 26, wherein the storage control unit allocates the second region based on region information determined based on a property of the user data.

34. The apparatus of claim 20, wherein the host terminal acquires information regarding the storage device, the information comprising at least one of erase unit information of a size used to erase data of the storage device, parallel unit information regarding a size of data that may be parallel-processed in the storage device, information regarding an address of a region in which a current data write operation is performed and an address of a region in which a data write operation is to be performed after the current data write operation, storage unit information regarding a minimum unit storing data in the storage device, and region identification information regarding the number of identifying regions that store data in the storage device.

35. The apparatus of claim 34, wherein the storage control unit transmits control information controlling to store and read data of the storage device based on the acquired information regarding the storage device.

36. A host terminal, comprising:
a packed bucket data forming unit to form packed bucket data by packing user data and a pointing map indicating a storage location of the user data, and
an extraction unit to extract a specific key value that is to be browsed by a user from the packed bucket data.

37. A storage device, comprising:
a smart interface unit to control to storing of packed bucket data by packing user data and a pointing map indicating a storage location of the user data, and to control the exchanging of a specific key value that is to be browsed by a user from the packed bucket data.

38. A method of managing data that is performed by a host terminal, the method comprising:
controlling, by the host terminal, to form packed bucket data by packing user data and a pointing map indicating a storage location of the user data, and
controlling, by the host terminal, to extract a specific key value that is to be browsed by a user from the packed bucket data.

39. A method of managing data that is performed by a storage device, the method comprising:
storing, by a non-volatile memory, packed bucket data by packing user data and a pointing map indicating a storage location of the user data, and
exchanging a specific key value that is to be browsed by a user from the packed bucket data.

40. A non-transitory computer-readable recording medium having recorded thereon a program for executing the method of claim 1.

41. A data management apparatus, comprising:
a host terminal including a first application and a second application, the first application generating first data and the second application generating second data; and
a storage device to allocate a plurality of regions to store the first data and the second data, based on a characteristic of the storage device.

42. The data management apparatus of claim 41, wherein the storage device allocates the plurality of regions, such that a size of the regions to store the first data and the second data are determined based on erase unit information of the storage device.

43. The data management apparatus of claim 41, wherein the first data is stored in a first region and the second data is stored in a second region, and
wherein a size of the first and second regions is determined based on erase unit information of the storage device.
